(19) United States
(12) Patent Application Publication
(10) Pub. No.: US 2016/0196513 A1
(43) Pub. Date: Jul. 7, 2016

(54) COMPUTER IMPLEMENTED FRAMEWORKS AND METHODOLOGIES FOR ENABLING CLIMATE CHANGE RELATED RISK ANALYSIS

(71) Applicants: CLIMATE RISK PTY LTD, Sydney, New South Wales (AU); SYDNEY WATER, Parramatta, New South Wales (AU)

(72) Inventors: Karl Mallon, Sydney (AU); Shane Brown, Sydney (AU); Erin Cini, Sydney (AU); Jessica Sullivan, Sydney (AU); Natalie Quinn, Sydney (AU)

(21) Appl. No.: 14/392,302

(22) PCT Filed: Jun. 26, 2014
(86) PCT No.: PCT/AU2014/000669

§ 371 Date: Dec. 23, 2015

(30) Foreign Application Priority Data
Jun. 26, 2013 (AU) 2013902354

(51) Int. Cl. G06Q 10/06

(52) U.S. Cl. CPC G06Q 10/0635

(57) ABSTRACT

Described herein are computer implemented frameworks and methodologies for enabling climate change related risk analysis. Aspects of the technology are especially applicable where a desire exists to understand risks in systems containing a large number of interdependent assets.

### FIELD OF THE INVENTION

The present invention relates to computer implemented frameworks and methodologies for enabling climate change related risk analysis.

### BACKGROUND

Any discussion of the background art throughout the specification should in no way be considered as an admission that such art is widely known or forms part of common general knowledge in the field.

Computer implemented risk analysis tools have in recent times become widely used across a number of fields. However, many of these tools suffer from significant shortcomings, for example in terms of limited flexibility and/or scalability, rigid data constraints, and time-intensive and labour intensive processing. There is a need in the art for improved computer implemented frameworks and methodologies for enabling more sophisticated and more extensive risk analysis. There is also the need in the art for improved computer implemented systems that all multiple individual and combines risk controls to be applied to an ensemble of assets, tested and compared.

### SUMMARY OF THE INVENTION

It is an object of the present invention to overcome or ameliorate at least one of the disadvantages of the prior art, or to provide a useful alternative.

One embodiment provides a computer implemented method for performing risk analysis for a system including a plurality of physical assets, the method including:

for each asset, defining an asset data item;

for each asset data item, maintaining data indicative of:

dependent assets, being other assets which will fail in response to a failure of the asset;

precedent assets, being other assets in respect of which failure will cause failure for the asset;

operating a risk assessment engine thereby to perform a risk assessment for the system, wherein the risk assessment engine determines an inherent asset failure risk value for each asset; and

maintaining a register of asset failure risks, which is populated with inherent asset failure risk values for the asset items as those are determined for the asset in isolation; and

for each asset, combining the inherent asset failure risk value for that asset with asset failure risk values for its precedent assets, thereby to define a total asset failure risk value of the asset.

One embodiment provides a computer implemented method including, upon calculation to a total asset failure risk value for a given asset, providing that value to all dependent assets of the given asset.

One embodiment provides a computer implemented method wherein the risk assessment engine is configured to determine inherent asset risk failure values for the assets in descending order of number of dependents.

One embodiment provides a computer implemented method wherein combining the inherent asset failure risk value for a given asset with asset failure risk values for its precedent assets is based upon a statistical sum for series risks.

One embodiment provides a computer implemented method wherein each asset data item includes data indicative of at least one of the dependent assets and precedent assets for its associated asset.

One embodiment provides a computer implemented method method for performing risk analysis for a system including a plurality of physical assets, the method including:

for each asset, defining an asset data item; and

for each asset data item, defining one or more element data items respectively indicative of elements that constitute the asset;

wherein one or more of the element data items represent external supply systems that affect operation of the asset, and wherein failure probabilities are defined for each external supply system.

One embodiment provides a computer implemented method wherein the failure probabilities are condition dependent.

One embodiment provides a computer implemented method wherein the external supply systems which are required by the asset to operate properly and include one or more of power supply, water supply, physical access, and telecommunications service supply and/or any other external supply.

One embodiment provides a computer program product for performing a method as described herein.

One embodiment provides a non-transitive carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1A illustrates a framework according to one embodiment.

FIG. 1B illustrates a framework according to one embodiment.

FIG. 2 illustrates a method according to one embodiment.

FIG. 3 illustrates a client-server arrangement according to one embodiment.

FIG. 4 illustrates an alternate embodiment of the framework of FIG. 1B.

FIG. 5 to FIG. 10 relate to the framework of FIG. 1B.

### DETAILED DESCRIPTION

Described herein are computer implemented frameworks and methodologies for enabling risk analysis and resilience testing, with some embodiments being described by reference to application in water utility operations and infrastructure.

### Overview

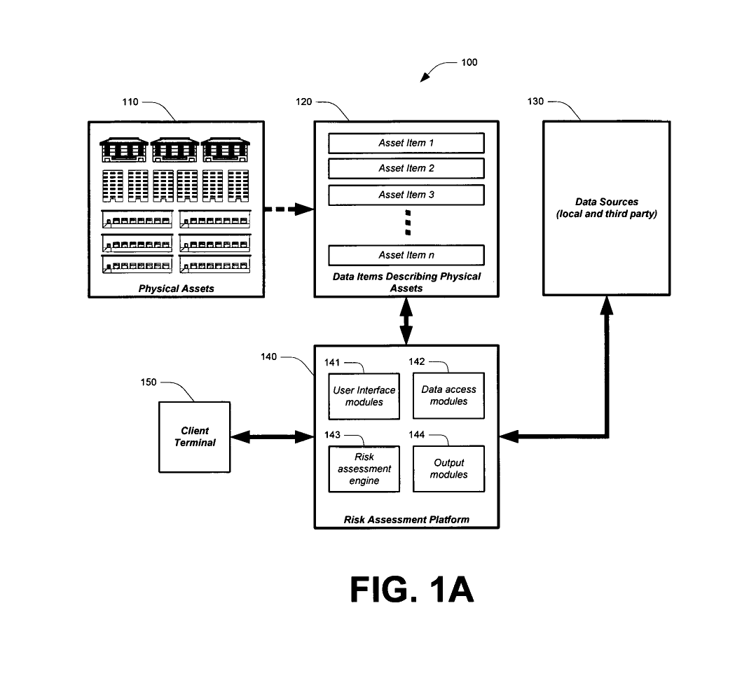

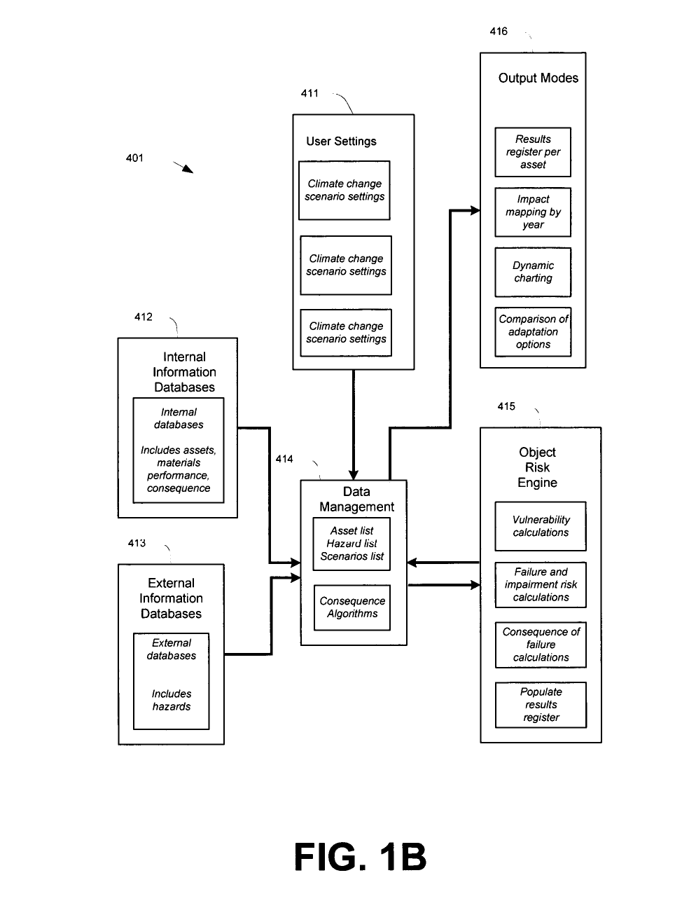

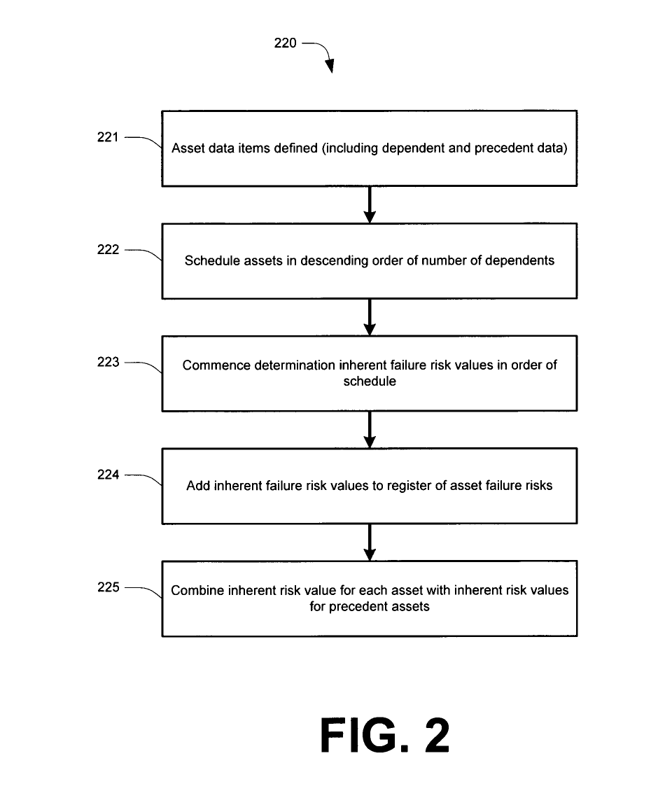

FIG. 1A illustrates an arrangement 100 according to one embodiment. In overview, arrangement 100 is intended to provide context of various technologies and methodologies described herein, particularly by reference to FIG. 2A to FIG. 2C. These technologies and methodologies are provided with further detailed context by way more detailed embodiments described further below.

In overview, the embodiment of FIG. 1A relates to risk analysis (also referred to herein as risk assessment) for a system including a plurality of physical assets 110, which may include substantially any physical assets (such as buildings, machinery, infrastructure, facilities, and so on). Physical assets 110 are described, in an information system 120, by “data items”. For example, a data item may be defined by a collection of associated data in a computer system, for example in the context of a database, matrix, or the like. Additional data sources (which may include both local data sources and third party sources) are also used, these providing the likes of spatial information, hazard information, climate predictive data, and so on.

A risk assessment platform 140, which may be defined by one or more computer program products defined by computer executable code, executes on a server device (or in some cases across a plurality of server devices). A client terminal 150 interacts with platform 140, for example by downloading HTML (and other code) from user interface modules 141, for rendering in a local browser, thereby to provide a local interface by which a user of client terminal 150 may interact with platform 140. For example, such interactions may relate to purposes including (but not limited to) adding/modifying data items, conducting risk analysis and/or modelling, defining modelling scenarios, adjusting analysis parameters, testing the effects of changed asset defining data items, machine-machine interaction, and so on.

Platform 140 provides for the use of data from archetypes, data dictionaries and prefilling matrices drawing from standardised national or international data on certain asset types, designs and materials performance.

Platform 140 includes data access modules 142, which are configured for interacting with data items 120 and data sources 130. In some embodiments modules 142 are configured to normalise (and/or otherwise “ensure operational integrity”) data obtained from third party data sources thereby to enable that data to comply with predefined local standards.

A risk assessment engine 143 is configured for performing risk analysis using data items 120 and data sources 130. For example, engine 143 may be configured to operating a risk assessment engine thereby to determine risk quantifiers for a physical asset, its elements and sub-elements based on a set of future conditions parameters (and optionally other modelling parameters and/or constraints).

### Management of Asset Dependence

FIG. 2 illustrates a method 220 according to one embodiment, also being a computer implemented method for performing risk analysis for a system including a plurality of physical assets. For example, this method may be performed by platform 140 in respect of assets 110.

Functional block 221 represents a process whereby asset data items are defined (for example during initial configuration). In this embodiment, there is a requirement that for each asset data item, data is maintained indicative of:
(i) dependent assets, being other assets which will fail or be damaged in response to a failure of the asset; and
(ii) precedent assets, being other assets in respect of which failure will cause failure or damage for the asset.

The risk assessment engine is operated thereby to perform a risk assessment for the system, the risk assessment engine being configured to determine an inherent asset failure risk and damage value for each asset. For example, this may be based upon disaggregation/re-aggregation of the asset, as described further above. A register of asset failure and damage risks is maintained, and this is populated with inherent asset failure and damage risk values for the asset items as those are determined for the asset in isolation. Then, for each asset, the inherent asset failure risk value for that asset with asset failure risk values for its precedent assets, thereby to define a total asset failure risk value of the asset. In this manner, the total failure risk value for a given asset takes into account its inherent risk of failure, and the risk of failure of all of its precedent assets (i.e. assets on which it depends).

In the context of FIG. 2, this is achieved by, at functional block 222, scheduling assets in descending order of number of dependents. For example, this may include defining a list order in which the risk assessment engine analyses the respective data items. At 223 determination of inherent failure risk values occurs, and these are added attached to the data associated with the asset and appended to the register at 224. Preferably, each determined inherent failure risk value is also inputted into a field in the register for each of the relevant dependent assets. In this manner, functional block 225 represents a process including combining inherent and precedent failure risk values (for example based upon a statistical sum for series risks).

Computationally, this approach is structured to maximise processing speed and avoid iterative rounds, compared with known risk management processes which are typically iterative and therefore time consuming. This increase in time-efficiency enables users to perform modelling based on varied attributes and/or future conditions without significant delays in awaiting generation of output data or to undertake more computations for some time.

### External Supply Systems

In some cases one or more of the element data items represent external supply systems that affect operation of the asset, and wherein failure probabilities are defined for each external supply system as the specifically apply to the asset. For example, engineering-level data items are defined to represent design envelopes for the likes of power supply, water supply, physical access, and telecommunications service supply.

This allows risk assessment to take into consideration the impact of failure of external supply systems, which are not modelled elsewhere in the risk assessment framework. By way of example, a likelihood of a power outage lasting a predetermined time may be quantified for a given external supply system. The failure probabilities are in some cases condition dependent. For example, the likelihood of failure in the case of extreme temperatures may be quantified, and referenced against the probability of extreme temperatures in an asset location.

### Context to Exemplary Tool

Climate change potentially poses significant challenges to water utility operations and infrastructure. Water utilities should be prepared to implement climate change adaptation responses that are effective, justifiable and represent sound investment. To address this need, the present disclosure proposes a tool which provides online risk and cost-benefit analysis designed to resolve the complex nature of climate change related business decision-making. The tool is configured to quantify and project the probability of damage and failure of assets by existing and future hazards, and assess and compare adaptation options.

Urban water utilities need to adapt not only to supply variability, which has largely been addressed via infrastructure investment and demand management over the last decade, but also to the impacts of climate variability and extreme events on urban water and sewage infrastructure assets.

Urban water and sewerage assets vary in size and function, as well as location (buried or above ground). Assets are impacted by sea level rise (salt water ingress, increased pipe corrosion), riverine flooding (inundation of assets, damage to electrical components, excess water in the system leading to overflows and pollution incidents), wetting and drying of soils (pipe cracking), severe storms (physical damage), temperature (changes to biological and chemical processes, physical impacts), and fires (physical impacts).

Climate change adaptation seeks to reduce the impact and cost of future climatic effects. As regulated entities, Australian urban water utilities must be prepared to implement climate change adaptation responses that are effective, justifiable and represent sound investment. These requirements highlight the need for quantitative analysis to support any future decisions.

Furthermore, adaptation planning must:
Minimise climate change risks to corporate objectives, at least cost (financial and non-financial).
Provide demonstrable evidence that a selected adaptation option is the, or one of the, optimal solutions.
Have a sound and transparent methodology, using plausible projections for climatic and non-climatic changes from reputable sources.

To address this need, technology described herein has been developed, with objectives including to:
Develop and demonstrate a robust and transparent computational climate change adaptation quantification tool for the water industry.
Resolve the complex nature of climate change related decision-making (including temporal, spatial, technical, financial, social and probabilistic information management).
Provide a flexible risk management investment/adaptation approach acceptable to stakeholders (financial controllers, independent regulators and environmental authorities) to allow effective climate change adaptation.

The present technology integrates GIS climate hazard data into a probabilistic computational model to assess databases of many thousands of water and sewerage assets. The tool is focused on the adaptation of urban water and sewage infrastructure assets. The tool does not include adaptation and/or management of water supply security, because this is already being addressed in a number of specific tools and planning processes within Australian urban water utilities.

The tool is an online risk and cost-benefit analysis tool designed to resolve the complex nature of climate change related business decision-making. This makes it possible for water utilities to consider a number of adaptation pathways against multiple assessment criteria. By including features such as uncertainly analysis, annual time steps and adaptation option triggers, the tool provides decision makers with feedback and flexibility as they seek to compare adaptation measures and their staged implementation. The development of a computational tool, rather than one-off desktop analysis, enables an ongoing adaptation management process which is dynamic, using up to date information and providing real-time analysis. This is a more efficient use of business resources than to analyse impacts and costs on an ad hoc basis where results can quickly become obscelete.

The tool can quantify and project the probability of damage and failure of assets by existing hazards and those made worse by climate change for sewerage assets (pipes, pumping stations, treatment plants, chemical dosing units, and odour control units) and water assets (pipes, pumping stations, treatment plants and chemical dosing units), and assess and compare adaptation options.

The tool enables users to select which hazards to assess and the source of the hazard information (databases store multiple spatial layers for different hazards and data sets from reputable scientific and government institutions to enable user flexibility). Assets are assessed geographically for a user specified climate change and impact scenarios. The likelihood of the climate change hazard events occurring (based on an annual probability of exceedance) at that location is drawn from spatial (mapped) data for current hazards held in the databases and projected for any year in the future based a comprehensive set of hazard algorithms.

The tool has been developed to include the climate drivers and hazards shown in the table below:

| Climate change driver | Climate hazard | Description |
|---|---|---|
| Sea level rise | Coastal flooding | Inundation of assets due to flooding from high sea events |
| | | driven by increased mean sea levels and storm surge. |
| | Salt water | Saline water from a tidal water table entering underground |
| | ingress | assets. |
| | Salt corrosion | The effect of salt water corrosion on assets which become |
| | | exposed to the tidal range due to an increased mean sea level |
| | | range either directly or via the water table. |
| Precipitation | Riverine flooding | Inundation of assets due to surface flows and increased river |
| | | heights during high precipitation events. |
| | Soil contraction | Drought events due to sustained low precipitation levels, |
| | | leading to damage from soils that expand and contract |
| | | significantly based on moisture content. |
| Wind | Extreme wind | Extreme wind gusts that exceed the design standard of |
| | | structures. |
| Temperature | Heatwave | High ambient temperature event that may exceed the design |
| | | envelope of structures or equipment. |
| | Bushfire | Fire event in grassland or forest which includes temperatures |
| | | consistent with direct flame exposure. |

The risk arising from a (climate-change-related) hazard requires both exposure to a hazard and a level of vulnerability to the hazard (the situation exceeds an asset's capacity to operate). To quantify the impact, The tool determines the extent to which each individual asset is vulnerable to the selected hazard. To determine asset vulnerability, The tool disaggregates the asset into elements (civil, electrical, mechanical, etc.) and defines the major material characteristics and design of each component part to establish its damage threshold and failure points of each.

Once the exposure of an asset (or group of assets) has been assessed then The tool uses the following process to assess the asset vulnerability:
Establish which asset materials are susceptible for each hazard event.
Establish which asset elements are therefore vulnerable to each hazard event based on the probability of damage/failure of the material.
Determine the thresholds at which the element will fail.
Determine the probability of the asset failing as a whole if the element fails.
Determine the flow on consequences to other assets and system operation due to the failed asset.

The tool also considers how each element works in the system to affect other assets and elements as a means to determine which asset elements are therefore vulnerable based on the probability of damage/failure of each element material. The flow-on consequences to other assets and system operation are alos captured through an analysis of dependence between assets. The tool also has the ability to include the effects of the original design standards of an asset and extent of degradation during its operational life.

Financial and non-financial key performance indicators are used to quantify impacts and include: annual risk of asset failure, risk of dry weather overflow, risk of environmental discharge into different categories of receiving water, equivalent number of residential customer service outages, risk cost (projected average annual financial loss) per year, loss of water quality and the cost of water ingress or egress, net present value of adaptation actions or ensembles of actions, cash flow and net present value of cash flow.

The tool is designed to provide an estimate of the projected average annual risk (financial and non-financial) associated with (the statistical probability of) asset failures. The tool calculates the Financial Risk Cost—total and annualised based on the:
Intrinsic Risk Cost—the direct asset costs for re-instating the asset, which may include repairs or replacement. The Intrinsic Risk Cost derives from any physical damage to an asset itself. The tool uses the asset replacement values taken from utility databases, as well as cost allocations for asset elements such as civil, mechanical and electrical components per asset type.
Consequence Risk Cost—the indirect consequential costs stemming from the asset's failure to operate. The Consequence Risk Cost focuses on the value of services the asset provides in terms of customers, quality and compliance, plus any associated (direct) monetary value.

The tool expresses financial impacts in terms of real dollars and the present value of expenditure or savings. Non-financial impacts are referred to in terms of other Key Performance Indicators (KPIs), such as salt water ingress volumes, unplanned outages or a failure to meet water quality standards; each of these KPIs has its own metrics.

In some cases a non-financial KPI, may also have a financial impact, for example salt water ingress into pipes results in higher pumping and treatment costs for the utility.

If the Intrinsic Risk Cost and Consequence Risk Cost are both monetised, their sum is captured as the annual Financial Risk Cost.

Indirect or external economic values are not included. For example, costs associated with penalities for licence breaches or payment of standardised compensation for loss of service are included in The tool, but ‘external costs’ associated with business disruption, reputational damage or environmental degradation are not.

Once the risk cost of impacts is determined by The tool, a sequence of adaptation options can be compared.

To assess adaptation responses, the tool requires users to specify adaptation options (a single action or a sequence of adaptation actions). Actions can be developed either by selecting from a pre-populated library of typical existing industry responses or by creating customised asset specific adaptation actions. The efficacy of an adaptation option is determined by re-evaluation of the impacts of climate change on the assets, and can be compared to the un-adapted asset or alternative adaptation options. The adaptation process involves:
Selecting a sub-set of assets that will be adapted as identified by the user.
Creating adaptation actions that adapt the asset by changing one of more of nearly 90 characteristics that define the asset. Or selecting actions from a pre-populated library of actions.
Combining actions in to a sequence to create a multi-action, multi-year, Adaptation Option.
Assinging CAPEX and OPEX costs to the actions.
Calculating the associated year of occurrence for any triggered actions, by reference to the climate change scenario settings specified by the user.
Re-analysing the asset risks, costs and consequences.
Comparing the Adaptation Options based on the aggregated overall performance of all of the assets with or without adaptation.

Existing embodiments have successfully delivered a climate change adaptation tool which:
Provides a robust and transparent climate change adaptation quantification methodology for the water industry.
Establishes a consistent approach to climate change risk and adaptation related decision making.
Enables the user to run scenarios and determine the impact on key financial, operational, and environmental performance indicators.
Compares adaptation measures to establish the cost-effectiveness of adaptation actions and allow prioritisation.
Provides a flexible risk management investment/adaptation approach acceptable to stakeholders (potentially including regulators).

For a single run of the model, the Tool can process up to 3,000 assets, annually for up to 100 years and includes a Monte Carlo statistical analysis of up to 10,000 cycles. For a single run The tool has the potential to do a billion cycles of risk analysis, allowing users to see the full probability distribution showing higher and lower projections.

Nevertheless the The tool has been optimised for speed, and a analysis of 100 assets, for a 100 years can take less than 1 minute. This allows users to explore risks and actions in ‘real-time’.

To make large volumes of complex information as accessible as possible, the outputs are presented in a variety of means including:
Expandable tables for each data set.
Charts for each of the KPIs.
Maps which show the data overlaid on satellite maps of the selected area.
Dynamic charts and maps which show how the results progress with time.
Charts showing comparison of adapted, business-as-usual and base assets.
Charts comparing various adaptation options.
Net Present Values for each adaptation option.
Exportable CSV files that allow data to be imported into other packages.

There are many types of uncertainty which affect The tool from more formal expressions of uncertainty such as those associated with climate change projections to more informal estimates used to accommodate ranges of opinion or variations in specifications.

The tool has been structured to accommodate uncertainty by allowing for ranges of data in many variables sampled by the tool. In general uncertainty is specified by the type of distribution used (e.g. normal distribution), and some expression of the range (e.g. standard deviation or highest/lowest percentiles).

The tool can be used to resolve the complex nature of climate change related decision-making for asset management (including temporal, spatial, technical, financial, social and probabilistic information management). The Tool has been developed to deliver a flexible risk management investment/adaptation approach acceptable to stakeholders (financial controllers, economic regulators and environmental authorities) to enable effective climate change adaptation.

By establishing The tool on a foundation of risk analysis, it is possible to apply different sets of adaptation actions to the system to explore how they reduce climate change risks. If this is done repeatedly, it allows different adaptation plans to be compiled and compared. This in turn allows the discovery of optimum adaptation solutions.

### Exemplary Embodiment of Risk Management Tool

FIG. 1B illustrates components of an exemplary framework for a risk analysis tool 401 for water utility operations and infrastructure according to one embodiment. This tool is configured to as an online tool, designed to assist in resolving the complex nature of climate change related decision-making. Tool 401 is configured to assist a decision maker to consider each of a number of asset management strategies/adaptation pathways against multiple assessment criteria, and includes features such as uncertainly analysis, annual time steps and adaptation option triggers. In this manner, tool 401 provides decision makers with flexibility to compare adaptation measures and their staged implementation. The development of a tool, rather than one-off analysis, is central to enable the adaptation planning process to be comprehensive, ongoing and flexible.

Tool 410 has primarily been developed for risk assessment in the context of utilities, such as water distribution networks. However, it will be appreciated that it has far widr applications.

FIG. 1B illustrates the interaction between main computational aspects of tool 401. These include:
User settings 411. The user inputs required for Tool 401 to execute a risk or adaptation analysis. The user must choose the geospatial regions being considered, assets to be analysed, climate change scenarios and financial criteria.
User settings 411 may be used multiple times in order to develop, apply and adjust adaptation actions and ensembles of actions.
Method of Adaptation, User setting 411 enables adaptation actions to be developed based ‘Object Orientated Adaptation’—that is, adaptation of an asset or system of assets is implemented via changes to the physical and design characteristics of the asset and its elements (i.e. the fields that make up the object matrix).
Internal information databases 412. To minimise the time required by the user to input data, tool 401 preferably makes significant use of databases. The databases securely store a purpose-built asset specification dataset for each user, which avoids the need for users to set up the model or input data. The databases also store ubiquitous generic asset information that can be used to specify certain attributes of common asset types. As well as assets, these databases store information about material performance based on the specific industry and material engineering standards.
External Information databases 413. Since some information, especially hazard data, will come from third party sources (e.g. weather bureaus, scientific institutions), Tool 401 provides for external data to be securely stored. This data is universally accessed by all users via the tool but is mediated by the tool so that users do not have direct access to the hazard data.
Data Management layer 414. A data management layer collects and grooms information before it is processed in the Object Risk Engine. This data management layer essentially acts a bridge between the high-speed processing engine, and the scenario-specific and user-specific settings and data required to execute the requested analysis.
Object Risk Engine 415. At the core of tool 401 model is an Object Risk Engine, which provides per asset and per settings, the computations. Here the settings, asset data, spatial layers and material performance information are brought together. For a single run of the model, the engine may process in the order of several thousand assets, annually for over 100 years, for example including a Monte Carlo statistical analysis of up to 10,000 cycles per year. So for a single run it has the potential to do a billion cycles of risk analysis. Therefore the processes described have been structure to ensure this computational engine has very high processing speeds.
Output Modes 416. Tool 401 may use a range of output modes to describe the results such as including charts, graphical, geospatial, maps of risk intensity, numerical presentation of Monte Carlo histogram distributions, asset risk breakout data tables, annual risk breakout data, elemental performance data and hazard impact summaries.

Tool 401 has, in this embodiment, been developed to use utility asset data combined with climate change hazard data to quantify the impacts and the costs and benefits of adaptation. A first step is to understand which assets are at risk due to being exposed to a climate change hazard. What this means in practice is that, to capture the exposure of assets to climate change hazards, the tool uses:
Hazard spatial layers which identify the extent of the hazard based on historical data
Asset data to determine the spatial location of the assets (object matrix)
Tables or spatial layers indicating future trends based on climate science
Equations for the annual exceedance probabilities (AEPs) trends to work out how likely it is for a hazard event to occur in a particular location for different climate scenarios

In terms of hazard exposure, the tool interprets hazards in terms of the probability of an event occurring that may damage or disrupt the asset. This means to operate there must be both a quantified definition of the ‘hazard event’, and probability of the event occurring (expressed as an AEP).

Using the tool, a user can assess the impact of climate change hazard on assets, for example water and sewerage assets, by selecting the particular impacts they wish to explore for each hazard, Hazard settings options include climate change scenario projections for each hazard (e,g. sea level rise), and analysis options which cover their resulting impact (e.g. coastal inundation). This allows users to interrogate specific issues as they see fit.

The hazard data in these various forms is used by the tool to:
Establish the annual probability of such a hazard event occurring per location, over the time period being analysed
Establish which materials used by an asset are vulnerable to each hazard event
Establish which asset elements are therefore vulnerable to each hazard event

The tool has been developed to include the climate hazards and drivers listed in the table below:

| Climate change driver | Climate hazard | Description |
|---|---|---|
| Sea level rise | Coastal inundation | Inundation of assets due to flooding from |
| | | high sea events driven by increased mean |
| | | sea levels and storm surge |
| Precipitation | Riverine flooding | Inundation of assets due to surface flows |
| | | and increased river heights during high |
| | | precipitation events. |
| Wind | Extreme wind | Extreme wind gusts that exceed the design |
| | | standard of structures. |
| Temperature | Heatwave | High ambient temperature event that may |
| | | exceed the design specification of |
| | | structures or equipment. |
| Temperature | Bushfire | Fire event in grassland or forest which |
| | | includes temperatures consistent with direct |
| | | flame exposure. |

Two types of hazard information preferably are available: historical hazard data from weather records, and projected hazard information from climate models. Historical data is generally available in fine-scale gridded data, e.g., one-square-kilometre pattern scaled GIS layers. Climate model projections are typically available only as more course-scale datasets, e.g., 100×100 kilometre cells, and in more rarefied time series, e.g., every two decades. Non-physical hazards may also be used e.g. cost of commodities, carbon, regulation change etc.

Empirical spatial information (both historical and current) is also collected, and is available from several sources, such as, using Australia as an example:
Weather station data from around Australia recorded and made available from Bureau of Meteorology (BOM).
‘Gridded’ datasets which contain manipulated recorded information produced by BOM or a third party. For example, pattern scaling to one-square-kilometre cells.
Conditioned hazard data drawn from measured weather data, possibly with additional modelling, used to draw out specific thresholds of hazards, e.g., for damaging winds data from the Critical Infrastructure Program for Modelling and Analysis (CI PMA), Geosciences Australia.

This information tends to be available in high-resolution GIS layers in spatial data formats either raster or vector formats.

In relation to modelled data, some data for ‘current’ conditions can come from models that bring together historical experience to model risk spatially. For example, to map locations for bushfire risk may amalgamate vegetation maps, wind velocity and direction records, as well as historical data for temperature and precipitation.

Some data may come from other real-time models on a per request basis, e.g. the ACE Canute model for coastal inundation.

Location specific accessing of data on a per location basis from spatial data sets may be used for or computation (though the tool is unlikely to allow this information to be used for direct display).

Modelling is often used for flood mapping in favour of measured flood information. Hydrological models are now quite sophisticated in estimating the return frequency in terms of the depth, velocity and extent of floodwaters, since severe floods occur too infrequently to make empirical data very useful or reliable.

Spatial hazard data can be available in GIS formats, but in some cases may only be available in report format, requiring a process of re-digitising for tool 401.

Climate change modelling can be obtained from a variety of sources in each country of regions, in Australia these include:
BOM/CSIRO general circulation models (GCM).
Multi-GCM amalgamated data sets, e.g., AusCLIM.
Specialist modelling, e.g., the NSW and ACT Regional Climate Model (NARCIiM).
In-house analysis or re-analysis, e.g., re-digitising of data from a report format.
Tool 401 maintains the capability to store external data on either a local server or one or more external servers that is referenced by the tool.

Hazard maps are, in this example, imported into tool 401 databases from GIS files. These are ‘mapped’ into a web framework (a data management and web management system and do not necessarily remain in GIS or other original format. Once in tool 401 databases, the information can be accessed on a location-specific basis. GIS data is not stored or used as GIS layers in tool 401 system, and instead is stored with intrinsic geo-referencing. This means that information about hazards at specific locations is accessible by location.

In relation to hazard databases, tool 401 preferably maintains a number of spatial data files available for use (for example in the order of 100 to 200, depending on implementation), preferably drawn from internal, mapping resources and from reputable and trusted external sources (such as BOM, Geosciences Australia and CSIRO).

In some cases additional contextual spatial layers of data are needed to establish the presence preconditions for a risk to occur. For example, since concrete cracking occurs mainly in clay soils, the tool database should also hold data on soil type.

An annual exceedance probability (AEP) for each of the hazard event is central to the statistical basis of tool 401. The AEPs provide the basis of probability of events occurring that carry through all probability calculations for elements, assets and combinations of assets.

AEPs are calculated annually for each hazard event and are location specific. Each is calculated based on a combination of:
Identifying the type or threshold of the event to be considered, for example the failure threshold of a material.
Acquiring event probability data from GIS layers for the specific location of the asset.
Adjusting the AEP, over time due to selected climate change projections and time.
Creating time based functions for AEPs.

Tool 401 uses the AEP of an ‘event’ creating time based functions for AEPs as a function of time, which is initially obtained from GIS layers for the start year as discussed above. These AEPs are then altered to reflect the effects of time based factors such as climate change using (a) an array of AEPs is preferred for each hazard/per each year/time step (b) an climate change adjustment coefficient [CCAC] (c) time based functions. These may be calculated for each year for each hazard and for each climate change projection scenario available for that hazard, as follows.

Hazard AEP_{year n}=Hazard AEP_{year 1}×CCAC_{year n}

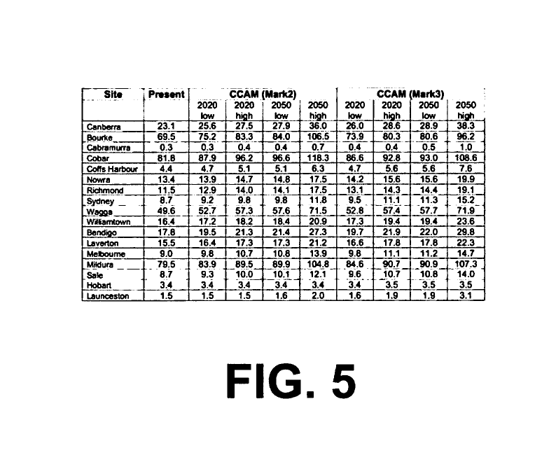

For example, CCACs can be created for two CSIRO emission scenarios: ‘Hennessy 2006, High’ and ‘Hennessy 2006, Low’ for, as an example, the Melbourne region, as shown in FIG. 5, which provides sample table for Forest Fire Danger Index projections for very high and extreme risk days for various locations from Hennessy et al. 2006 which is preferably used as one of the sources for the climate change projections in Tool 401. This coefficient would take a value 1 in the start year, and increase each year up to 1.23 or 1.63 in 2050 subject to the selection and according to a suitable curve fit.

In some cases data is spatial, and as such must be acquired using the spatial acquisition systems developed for the assets. Data sources for climate change projections are diverse and highly variable in terms of how they present climate information, from highly specific quantified mapping to broad scale regional indicators. Such data may require significant processing before use. However, preferably data is synthesised into a set of CCACs for each selectable climate change scenario.

In some cases AEP's must be obtained on a location specific basis and then defined by a location specific mathematical function for each hazard severity and time dependence.

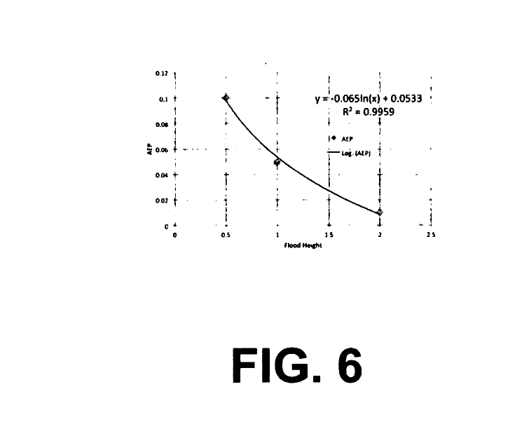

In some cases the data from the hazard maps cannot be used directly because some level of interpolation is required to extract the required AEP. Tool 401 uses regression functions to do this. In essence, these apply a curve fit to a set of data, so that a universal relationship is established for the parameters and this then allows the probability of specific threshold to be extracted, for example in FIG. 6. The tool uses specific code to take the GIS data and fit linear, log or other curves. The function coefficients can then be extracted and used for interpolation. The nature of the curve that is fit to the data is based on literature research of the industry best practice.

For example, in the case of flood risk to an asset's mechanical systems:
The height of civil elevation (effectively floor level) is taken from an Object Matrix for that asset.
The height of flooding for at least three return frequencies at the asset's location are acquired from the GIS layer data stored in the tool's databases.
A log-normal curve is created using this data to derive the projection curve for flood height versus AEP.
Using this curve, the AEP for the threshold failure heights is calculated.
This, then projected forward using a suitable function due to climate change and other temporal factors.

Tool 401 interprets hazards in terms of the probability of an event occurring that may damage or disrupt the asset. This means to operate there must be (a) a quantified definition of the ‘hazard event’ and (b) and probability of the event occurring (expressed as an AEP).

An important requirement for the tool is that the hazard can be meaningfully interpreted in terms of its impact on the materials/components that make up an asset or its overarching design standards. The relationship between materials and hazard driven failure is carefully constructed via, for example, the Material Failure Coefficients which identify the key aspects of a hazard that need to be captured for the tool to calculate the likelihood that a asset material will fail—for example the range of temperatures during a bushfire, flood, heatwave, or ingress, the peak wind speed during an wind storm. Thus, from a generalised reference to a hazard type, an asset relevant specific parameter is tracked in time and space in combination with its frequency of occurrence.

What this means in practice is that, to capture hazard information and trends, Tool 401 has access to the following information:
Spatial layers which identify the presence of a hazard based on historical data and its probability of occurrence and extent;
Tables or spatial layers indicating future trends based on climate science and other time dependent factors;
Equations predefined or tool generated that describe the AEPs trends for the key hazard parameters for different climate scenarios.

The hazard data in these various forms is used by the tool to:
Which assets are exposed
Which elements are exposed
Which materials are vulnerable
The probability of failure of a material when exposed to a hazard
Establish which materials used by an asset are exposed to each hazard event
Establish which asset elements are therefore vulnerable to each hazard event
Establish the annual probability of such a hazard event occurring per location, over the time period being analysed

The hazard databases are in some cases very large—going to hundreds of gigabytes—and so hazard information in accesses on an as-needed basis in real time. Only when a user has selected the assets they want to analyse and the hazards they want to consider and the climate projections they want to test is the required hazard data retrieved from the data-bases.

Tool 401 is generally used to compare ‘adaptation options’. For a given option, users can assign a name to a project scenario carried out by the tool. Many assets can be included for testing in an Adaptation Option, but this allows for unique versions of a specific asset to be compared.

In Tool 401, the project scenario refers to the external and internal conditions or settings that will be imposed by the tool on the user and its assets. These include:
Climate settings—such as greenhouse gas emissions trajectories or sea level rise rates.
Financial parameters—such as the cost of capital and NPV periods.
   KPI—settings
Compliance parameters—such as the cost of license breaches.
   Advanced settings relevant to system or client
Technical settings—such as the internal cost of wastewater processing or the like.

The project scenario settings interface is separated into ‘normal’ and ‘advanced’ sections. The parameters that are easily understood and likely to be used in sensitivity analysis are available in the normal section. Settings that require a more advanced technical understanding on the part of the user are found in the advanced section. The administrator sets the advanced settings as accurately as possible, so that users can leave these settings as they are and still produce sound model runs. Users can create and save their own ‘default’ project scenario settings and then to load these at the beginning of an analysis session. These default settings remain available for that user. Settings can be changed with some assets to create sensitivity/scenario analysis.

The project scenario setting interface is set according to climate change projections available in the scientific literature. For example, the Sea Level Rise setting allows the user to select a range of options from less than half a metre to over 1.5 m by 2100 each from reputable sources such as the IPCC. The user can also be given some guidance as to the relative position of each choice i.e. high, medium and low. In some cases additional guidance mat be given, for example if a choice is one that is recommended or required by state government.

If there is an absence of specific, year-by-year data for a specific choice, the tool creates a functional fit between available data points, will based the year by year data on an adjusted representative projection e.g. Sallenger 2012 sea level rise projection curves.

Tool 401 allows users to select the particular impacts they wish to explore for each hazard. Hazard setting selection options include existing hazards and those caused or exacerbated by caused by climate change (e.g., sea level rise), as well as their resulting impact (e.g., coastal inundation). This allows users to interrogate specific issues as they see fit. Computationally, data source selection is handled by tool 401 data management code. The code first lets the users view the available overarching climate change hazards that can be analysed. The users can then select which direct impacts they wish to assign for analysis by the Tool.

Tool 401 uses Monte Carlo systems, built into the code, to manage uncertainty in data and produce results that can be expressed as probability distributions. Monte Carlo methods are a class of algorithms that rely on repeated random sampling to compute their results with a range of uncertainty consistent with the inputs. They are often used when simulating physical systems.

If one or more inputs have a range of possible values with some associated probability distribution, a Monte Carlo system takes a random sample of each range for each run of the model and uses this to compute its results. The tool repeats this process over and over again, each taking a random sample from the range. The random sample is taken equally from across the range, but reflects the probability distribution of the range—so a value in the range which has a 30% probability of occurrence will, on average, be used 30% of the time in the random sampling.

This allows multiple data sets and or ranges of expert opinion to be used in a statistically valid process. For example a Monte Carlo process can allow for a normal distribution of possible bushfire temperatures to be combined with a triangular distribution of failure risk for a material, to calculate a risk of failure that is consistent with the probability distributions of each of the inputs.

Users can define the duration of the analysis and the number of Monte Carlo runs to be performed. The number of Monte Carlo runs affects the statistical accuracy of the resulting probability distributions. There is a processing time penalty; if users wish to analyse large numbers of assets, a low number of random probability samples (Monte Carlo setting) should be used. For example, choosing a Monte Carlo setting of ‘1,000’ means that 1,000 cycles of different randomised inputs are used per time step (for parameters where we have a range of possible values), perhaps for 100 years selected and for 100 assets, and for five hazard impacts. This requires the model to execute the Object Risk Engine half a billion times.

So as to provide an exemplary implementation scenario, tool 401 may be configured to analyse risk in the context of water/sewerage infrastructure (although tool 401 is certainly not limited to that field of use). In that implementation scenario tool 401 may be developed to include the following water and sewerage asset classes:

Tool 401 includes an object-oriented computational model. Essentially, an asset is managed by the tool as a series of ‘objects’ that capture the different phases of the asset's life over the analysis period. For example, a cast iron pipe that is replaced with a PVC pipe in year 2030 and then relocated in 2070, is represented by three discrete ‘objects’ in tool 401. Should the user make further adaptations, more objects would be created.

An object is defined by a plurality of fields, typically 100 fields for sophisticated infrastructure assets, in an asset database template known as the Object Matrix. Each of these 90 columns is referred to as a ‘data field’. Each of these data field holds a single piece of information about an asset.

The Object Matrix is ubiquitous to all users and asset types its may be consistently configured for a single application of the model but change across application type e.g. the Object Matrix for water has 12 elements or the Object Matrix for building has 40 elements, remains in the same form so that it can be uploaded into tool 401 databases.

In its complete form, the Object Matrix is a matrix with a row for every asset. However, during data collection the columns may be split up into the categories to make the data collection phase easier.

The object matric will include fields which may be redundant for some assets. In the case where data fields are not relevant to a particular asset class, they are preferably marked as ‘Not Applicable’.

The Object Matrix in essence performs three functions
1. It defines the data required in each column, including units, format, datum, and naming convention.
2. It orders the data in a form that is ubiquitous for all to ensure consistency when processing and uploading into tool 401 database.
3. It allows the location of data and data custodians to be tracked, and provides Meta data or how data was extracted or derived, or alternatively, why it was not available or could not be made available.

In this case data tracking is best separated from data collection. To address this, a single master file of the Object Matrix can be created for each user to provide a single location (or file) for tracking information for all assets.

Quantity data of an asset can include capacities, age, dimensions and other quantified attributes. Quantity data is typically supplied in attribute tables as part of GIS information, but these data may come from other non-spatial databases owned by users and are matched across databases using Unique Asset Codes.

Cost data are generally sourced from asset management databases using an asset's Unique Asset Code. These databases sit separately from GIS datasets. Where costs are provided against Unique Asset Codes, no assumptions or interpretations needs to be made and asset values are inserted directly into the object matrix. In some cases, a single asset replacement value was not provided by a user. There are variations on this:
By database
By cost range
By manual entry
By aggregation of sub component value

Where several components belonging to a single asset existed, their values may be added together to calculate the total asset value.

Modelled data covers data that is required as an input to tool 401 but is not already available as a value in pre-existing databases. This includes data that must be modelled using other software before being available for the Object Matrices such things as: asset volumetric capacities, asset volumetric flows, number of customers, receiving waters and backup for assets connected to an electricity grid.

The Object Matrix has definitive required forms, units and projections for all data. Therefore, any data not supplied in the form specified in the Object Matrix has to be converted into the right form, unit or projection before it can be uploaded to the tool database.

Tool 401 does not require that every field be completed in order to operate; fewer than ten fields maybe adequate for the system to operate and provide useful analysis. However, the more information that is available, the more extensive the results will be.

Data above the level required for basic function can be roughly organised into the following layers: asset dimensions, connectivity and redundancy, capacities, historic risk, impacts (customers and environment) and connections (asset function in the network).

In most cases, use of data above the basic level may require a significant increase in resources to either locate and collate the data, or generate it using models.

Although the minimum amount of data required by the tool still produces meaningful results on an individual asset level, each additional layer of data either increases accuracy of calculations or improves the assessment of an asset's effect on the environment, customers or other connected assets in the network.

In relation to spatial data, assets must be placed in space in order for the model function. Latitude, longitude and elevation data give the location information for an asset.

In most cases the location of each unique asset can be generated from the GIS layers. The latitude/longitude data links assets to other spatial data sets that can be used to draw in other required information e.g., hazards or DEM.

Assets can be located in a multitude of ways e.g. centroid point or polygon. For facility, storage and network types of assets this location can be the centre of the asset site. For linear (long) assets the centroid is the centre of linear geometry of the main, even though some pipes may be curved.

Users can provide spatial data as either latitude and longitude attributes for each asset, or in the form of GIS layers, which can be queried for asset location or other asset attribute data. Every entry in GIS layers has a unique spatial position and a unique code for asset identification.

Lists of ‘Unique Asset Codes’ are generated by Climate Risk from the GIS layers provided by clients. These codes were then sent to other data custodians within a user to query other data types, for example, cost information.

The Unique Asset Code is crucial to link information about a specific asset across all databases.

A digital elevation model (DEM) is generally required if users are unable to compute floor heights and relative levels directly for each asset. This DEM can either be provided directly to the project or calculated using terrain data.

Some users can provide GIS hazard maps for their area of operations. For example Sydney Water provided a Digital Terrain Model (DTM) with one-metre contour lines. To interpolate between contours Climate Risk used ESRI software to it converted into a Digital Elevation Model (DEM).

The DEM is crucial to establish the relative height of asset structures with reference to sea level and/or ground level, which is required to compute flooding, inundation or erosion risk.

Ground heights for assets can be taken by querying the DEM at the centroid location of the asset.

### Archetypes

Physical dimensions and constituent materials are relevant in the model because it is not possible to quantify the risk to the asset from various hazards unless that asset's position in space and the configuration of its elements are known with some degree of accuracy. To solve this problem, archetype databases have been developed for each asset subclass.

In Tool 401, a typical asset is a generic set of Archetype specification and physical properties (included in an asset template) used to create ‘typical’ representation of an asset in space so it can be assessed against the spatial hazard data by the model.

The Archetype Specifications specify elevations of asset elements relevant to ground height, e.g., floor height, lowest point in structure, and minimum elevations of electrical, mechanical, and civil elements of an asset.

The Archetype specifications specify default materials and other properties such as waterproof-ness for each asset element. In order for an asset to use an archetype template, a ground height must be available at the asset's location so the Archetype Specifications can be converted into height datum. Tool 401 model uses height datum for all levels.

Creating a archetype for each asset subclass in tool 401 Model has allowed for easy integration of any asset subclasses that may be added during the rollout phase. If a new asset subclass is added to tool 401, its corresponding archetype template will be added to the archetype database for that asset class.

Data used in the development of the Archetype can be provided by participant users.

In a first step toward developing Archetypes, the asset management reports and as-constructed drawings are analysed and interpreted in terms of the fields required by the Object Matrix. For example, for the depth of a civil structure or the height of electrical units.

Industry sectors often disaggregate their assets into elements. Each element varies in its expected lifetime and fractional value of typical asset. Tool 401 uses standardised sets of asset elements e.g. civil, electrical, mechanical, electronic, etc.

In the Object Orientated Adaptation system external elements are also included in the elemental characterisation of an asset, e.g. power information (data links), water, and access (e.g., roads),. All assets are characterised by the presence of each of these elements, and the result is expressed in binary form in a matrix.

An asset disaggregation tables can be taken at an archetype level if available for the individual asset. This shows which of the asset element breakdown are typically present in that asset-type, and the function of these elements.

Replacement asset values are provided for the whole asset, including breakdown into values for each asset element. In principle every asset has its own asset element value breakdown. For simple assets, the entire value may rest with the civil element. For complex assets, the entire value is the sum of the value of every element. These values can be expressed in an actual value or as a fraction of the asset's replacement cost, which can be updated to ensure currency. In this way, the cost for each element can be easily re-calculated if the total asset value increases or is indexed with CPI.

Asset Value=Σₑₗₑₘₑₙₜₛ Element Value

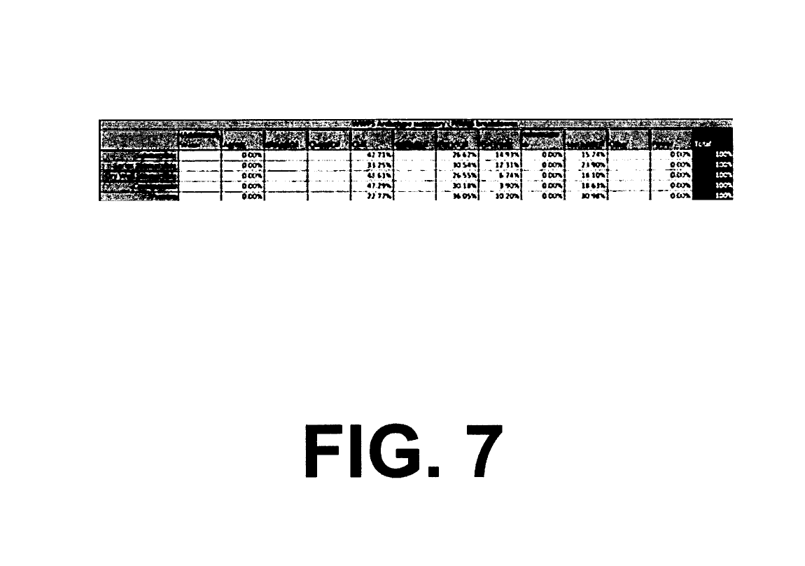

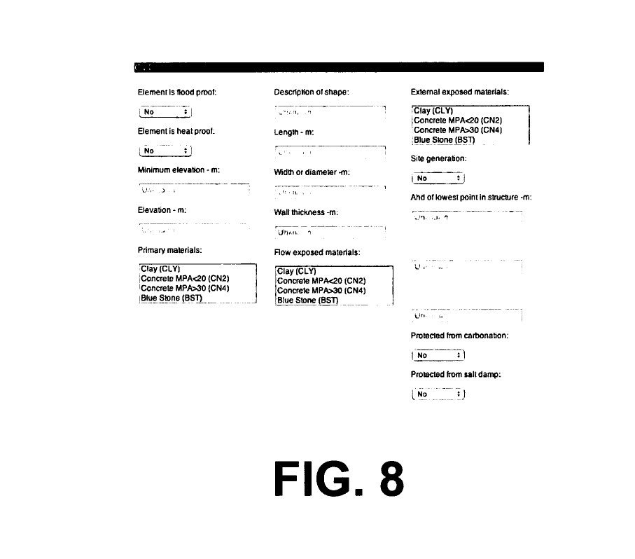

The asset value can be stored either in aggregated Although certain utilities know the element values for some individual assets, the object matrix only stores a total value for the entire asset. To assign values to each asset element, an Asset Element Breakdown for each asset-subtype is derived based on an average e calculated from similar assets. This process is detailed in this report's data acquisition section (see FIG. 7).

By allowing Tool 401 to break down an asset's value into a series of sub-elements, the Asset Element Breakdown provides users with a better allocation and assessment of of impact costs. This is the main advantage of this feature.

The Dependent Value of an element is the sum of the element breakdown values for all dependent. The Dependent Value captures the amount of Asset Value dependent upon this element in the event of its loss or failure. For example, if a civil component of an asset such as a building structure is damaged in an extreme event, many other ‘dependent’ elements in that building, such as the mechanical and electrical equipment, will be damaged as well. When an element that, upon failure, results in the whole Asset Value being impacted, it is assigned a Dependent Value of 1. Alternatively, an element for which damage/failure has no effect on the asset value would be assigned a Dependent Value of 0. An example of the latter situation would be a situation in which the loss of the Power element stops the operation of the asset but does not cause damage.

Asset failure dependency seeks to understand which elements of an asset, should they fail, will cause other elements of an asset to fail, and/or an asset to fail completely. For example, a failure of power, or of civil, mechanical or electrical equipment that would cause a failure of the whole asset. Failure of a data link would not cause the asset to stop working, but it would not be remotely operable.

A set of binary (Boolean) matrices is used to identify whether, for a typical asset, an element will cause asset failure. Information in the matrices is based on professional analysis of each asset subclass, information from user asset management plans (AMPs), and in some in some instances design codes.

Archetypal Asset Dimensions are used as a proxy when specific data on assets elements are lacking. AADs are required, in the absence of any asset specific data.

Asset archetype templates are based on a range of documents, expert advice and logical deductions. These templates are used as a proxy when there is a lack of data about a specific asset, but the asset is a member of specific asset class that is well understood and characterised by an archetype.

Using archetypical or assumptive data, Archetypal Prefilling Templates cover qualities such as flood proofing, fire proofing, criticality rating, connectivity, impacts of failure, construction materials etc.

As constructed diagrams for each asset subclass were used to extract archetypal information, as noted above.

To determine the approximate dimension and spatial location of different asset elements within an archetype, sample sections of ‘as constructed’ drawings were marked up to show relative levels of elements. They were used to develop AADs.

Every asset will degrade unless there is intervention for renewal. How much an asset has degraded is clearly relevant to its overall resilience, and therefore the risk of damage and failure when faced with climate related hazards. Tool 401 has several techniques to manage degradation.

As a first approximation of degradation, when creating an Adaptation Option the user is able to specify the amount of degradation allowed over the life of the assets being analysed. The life of an asset as a whole is assumed to be equal to the life of the civil element (other elements can individually have shorter design lives). So for example the user can specify that, in general, all assets will have degraded by no more that 30% by the time they reach the end of their design life. This is intended to be a proxy for a generalised asset management strategy and degradation envelope. This feature also allows a user to test the impact of more aggressive degradation situations for the specific class of assets they are testing or different levels of maintenance.

The degradation process can be eliminated by specifying a zero level of degradation either in the base asset or by assuming that a BAU strategy would at least maintain assets at their design specifications—and therefore with no degradation.

Finally, the BAU process can also be used for specifying a renewals strategy for the asset and its elements, which can be a means to re-start the clock on the degradation.

Computationally, the level of degradation is assumed to increase both the intrinsic risk of damage and the consequential risk of failure for the asset. The levels of intrinsic and consequential risk increase are assumed to be proportional to the level of degradation, and similarly the level of degradation per years is assumed to change with an appropriate function over its lifetime.

To accommodate some uncertainty in the level of degradation and its impact on risk, the effect of degradation is assumed to vary between xxx level (e.g. +20% and −20% of the pre-set values) and this is re-sampled according to the number of Monte Carlo cycles of the model for each year of the run (based on a probability distribution).

### Asset Filtering

Tool 401 uses asset filtering system. This system has been created to help users focus on the types of assets they wish to consider in the analysis. Filtering is performed according to asset subclass. This approach was adopted to minimise the volume of assets processed by allowing the user to focus easily.

The filtering system uses the asset subclasses included as archetypal assets. The asset selection function provides selection flexibility by allowing the user to filter assets by an individual subclass or multiple subclasses. If no options are selected in the asset subclass tab, all assets will be loaded; this will also occur if all asset subclasses are selected. If a single or multiple subclasses are selected, the assets pertaining to those subclasses will be loaded into the system and ‘deployed’ in the assets tab.

Tool 401 includes a regional selection interface that allows the users to see assets displayed on a map, in conjunction with commonly used mapping data (e.g., topography, roads, street names), which helps to provide context. Individual assets are displayed as orange dots and groups of assets as green circles. Green circles break out into orange dots as a user zooms in. Clicking on a dot or circle allows the user to see the asset code(s) for the assets in that area.

### Geographical Filtering

Assets can be selected using a multi polygon ‘lasso tool’. The lasso tool is activated by clicking the yellow diamond button shown on the top right of the figure below. By then clicking around the group of assets, the user can capture them in the polygon with a final double click. Multiple polygons can be drawn during the asset selection process.

The lasso function is integrated with the other parts of the tool, and reduces the ‘asset types’ and (individual) ‘assets’ on lists to those captured in the polygon. Once the polygon (or polygons) is selected the tool automatically updates; when users proceeds to asset type selection, only those included in the polygon(s) are available. If the user moves from asset type selection straight to asset selection, all assets in the polygon will be made available in the list for analysis. From this point the user can include or exclude individual assets as they see fit.

The advantage of using the polygon lasso tool is the ability to further focus the number of available assets in the next steps of the tool. However, should the user choose to skip straight to the next tab without specifying an area with the lasso tool, the tool will automatically load all assets in the user's full operational area making them available for analysis. The user can then narrow down their selection on both the asset subclass and asset selection tabs, which are explained in the section on asset filtering below. A user will generally opt for this method if they are interested in analysing either all assets or some subset of assets across the entire area of operation.

In tool 401, the risk arising from a (climate-change-related) hazard refers to a hazard that will introduce a situation that affects an assets capacity to operate. Such a hazard may result in exceedance of the design specification for an asset element. For example, on a very hot day the operating temperature range of the motors may be exceeded. Delving further into the constituent parts of the asset, the operating envelope of the materials that make up that asset element may be exceeded.

### Material Functions

Each asset Element (civil, mechanical, electrical, etc.) consists of various materials and designs. In some cases an asset will be made of a single material (such as PVC), but in others, several materials will be used. For example, in a steel pipe with cement lining the steel provides structural strength and cement protects the pipe from corrosive liquids. For each element, the different materials and their main function are captured in tool 401 Object Matrix, thereby making this information available for analysis by Tool 401. This information is central to Tool 401's capacity to assess a given asset element's performance in the face of various hazards.

For example, a pumping station may fail to operate due to a bushfire. This failure may be caused (in the first instance) by the electrical element failing, which in turn may have been caused by the melting of plastic coatings on the electrical wires (leading the pump's power supply to short-circuit).

The key determinants of the potential failure/damaging of an element are:
1. Whether an element is exposed to the full impact of a hazard and;
2. The probability that an element's material(s) will fail when exposed to the hazard.

In Tool 401, the following locations hold these key determinants for each element of a given asset:
1. Element Exposure Matrices and;
2. A matrix of Material Failure Coefficients (MFC).

The Element Exposure Matrices can be compiled using an analysis of as-constructed diagrams for asset sub-types, but these matrices can be modified or customised to suit individual assets. Material Failure Coefficients are discussed in more detail below.

Data is acquired from hazard maps once an asset has been selected for analysis. The tool obtains the relevant location from the associated Object Matrix, looks up the hazards that the users have requested be scrutinised, and acquires the data from each of the hazard maps available. Although the form of data in each map may be different, it is generally converted into occurrence probabilities of a hazard event.

Each asset or archetype has an exposure matrix that shows which asset elements (e.g. civil, electrical, mechanical, access, etc) are exposed to which climate change hazards. For example, although a wastewater pump is not directly exposed to bushfire as it is eight metres underground, the power connection for this pump would be exposed to bushfire.

Exposure matrices are based on professional analysis of ‘as constructed’ drawings of each asset subclass and information from user AMPs.

The Exposure Coefficient for an asset element is drawn from the Element Exposure Matrix for an asset subclass. This coefficient is a binary variable that indicates either that this element will be exposed to the hazard event, or that it is protected by other elements or unexposed for some other reason. For example the civil structures of a submersible pumping station may be subjected to fire but the submerged pump inside will not. Thus the Exposure Coefficient of the civil element would be 1 (exposed), and the mechanical element 0 (unexposed).

The probability that the asset will fail is referred to as the Asset Failure Probability. This depends on the hazard, and the exposure and vulnerability of each of the elements. The mathematical aggregation of the element risks is carried out based on whether these are risks in series or in parallel, or a combination of the two.

$$Asset Failure Probability = {}_{}^{statistical}{Σ}{}_{elements}^{} ( Element Failure Probability \times Failure Dependence )$$

$$Element Failure Probability = Hazard AEP \times Exposure Coefficient \times Element Vulnerability$$

The AEP of a hazard event has been introduced in the hazard chapter above, and these equations show how these values are taken up in the computation. The Hazard AEP tells the tool the annual probability of an event occurring—often very small probabilities of a less than 1%, but these can be much higher or even exceed 1.

Next the tool establishes which of the elements of the asset are exposed to the hazard and to what extent via the Exposure Coefficient. So for example, a civil component of a building, which would include the walls and roof, will be exposed to wind hazards, where as the electrical elements inside will not as they are protected from this hazard by the civil structures. So the civil element would have an Exposure Coefficient of 1 with respect to the wind hazard, where as for the electrical element this would be zero. If the situation is not so black and white, perhaps for electrical switching boxes 50% of the time they are inside the structure and 50% outside, then a value between zero and 1 can be used, e.g. 0.5 for the exposure coefficient.

The Element Vulnerability is the probability that the element will fail when exposed to the hazard event. This is assumed to be equal to the probability that the material(s) making up the element will damage/fail when exposed to the hazard event, that is, the Material Failure Coefficient, described in more detail in Section 5.

The Failure Dependence tells the tool the probability that the asset as a whole will fail if the element fails. When all summed together for each element, this provides the overall Asset Failure Probability.

The Element Vulnerability is the probability that the element will fail when exposed to a particular hazard event. This is assumed to be equal to the probability of damage/failure of the material(s) that make up the element when exposed to the hazard event, otherwise known as the Material Failure Coefficient (MFC).

MFCs are drawn from the material performance database embedded in Tool 401.

Risks to integrated system assets such as infrastructure due to climate change hazards generally relate to an asset's failure to perform, that is, its failure to perform its intended role in the system. Asset performance failure may have consequences for financial and non-financial KPIs.

An asset fails because one of it component parts (elements) fails. Elements may fail for many reasons: due to their damage and breakage, loss of the inputs needed for operation (e.g., power or telecommunications), or because the element is outside its operational envelope (e.g., its safe operating temperature).

Each asset element is composed of one or more materials. The behaviour of these materials, either individually or in composite, when exposed to a climate related hazard can give rise to element failure and subsequently the asset failure/loss.

For example, consider an infrastructure asset that has a civil structure (Civil Element) made from concrete. When exposed to a bushfire the Civil Element is likely to be damaged because bushfire temperatures often exceed the damage threshold for concrete. This means the Civil Element is at risk of failure, as are all other elements of the asset that depend on the Civil Element. Therefore the asset as a whole is at risk of failure.

To summarise, we can calculate the extent to which an asset may be at risk if we know how the materials that make up the asset will perform when exposed to a climate change hazard.

The Material Failure Coefficient (MFC) for a given material and hazard is the probability that the element using this material will fail when exposed to a hazard.

Tool 401 selects MFCs if the conditions for their relevance are satisfied. A MFC is useful when the causes of failure are relevant, but is not useful (and can be misleading) where the conditions are not relevant to the failure of the element.

For example, the brittleness of pipe materials is relevant when considering the problem of soil expansion and contraction in soils which are prone to expansion and contraction (e.g., clay based soils), and when analysing the likelihood of a hazard likely to cause contraction of soils (e.g., drought). Thus an MFC for pipe cracking can be invoked if there are clay soils present and if the effect of drought is being analysed.

Tool 401 allows assets to be specified so that one or more of their elements has design features that override normal material behaviour. This feature addresses the limitation of MFCs where an asset element or asset has been deliberately designed to manage the underlying material characteristic. For example, although some mechanical systems become strained between 40 degrees Celsius and 50 degrees Celsius, it is possible to extend the upper temperature threshold for a mechanical system's operation by changing the design (e.g., by using introducing oil cooling). Similarly, materials can be waterproofed or protected against corrosion. Users can also apply (adaptation) actions that override normal material behaviour at some point in the future.

Some MFCs can be easily quantified. For example, the probability that an ‘electrical material’ will fail when submerged in water is 100% unless it has been purpose built to be waterproof.

For other materials and hazards the impacts are not as clearly defined. In these cases MFCs may need to be derived from probability distributions of hazards and material relationships, analysis of historical trends, or industry expertise. For example, the ability of a material to withstand a bushfire depends on the heat intensity of the bushfire; for a projected future this can only be estimated using a probability distribution. Similarly, the probability of a motor overheating in a heat wave depends on many design characteristics. Since these characteristics cannot be known by the tool, a probability of overheating must be derived based on a large sample of historical experience.

Using known behaviour for materials for which data is available can be used to obtain a relationship that can be extrapolated to other materials. In this way each MFC can be developed to a range of relevant materials.

For example, empirical data collected by engineers on the vulnerability of a pipe to soil expansion and contraction indicates that the brittleness of the material used is a key factor. The physical characteristic used to measure brittleness is Poisson's Ratio. By aligning the empirical data about probability of failure with the Poisson's Ratio for each material, a mathematical relationship can be established (by regressing the coefficients of a suitable line-fit). Using this relationship it is possible to interpolate or extrapolate for the vulnerability to soil expansion and contraction of a pipe material for which empirical data is not available.

In other cases it is not possible to directly infer the probability of failure. Instead a range of material response can be used to create a MFC for a given material. For example, where structural failure is concerned, Ultimate Strength clearly quantifies material strength. However, the actual risk of failure is affected by thickness and design. Therefore, the MFC for structural failure must be complemented by other information about the asset from tool 401 Object Matrix—such as rated design performance to a hazard.

A Material Performance Database is a catalogue of the Material Failure Coefficients that are used to test element materials against the hazards to which they are exposed.

The various assets of a user act in a concerted fashion, not individually. Therefore the failure of one asset affects other assets and consequentially the system as a whole.

Typical ‘systems analysis’ code is based on stocks and flows, for example, inputs, storage, internal flows and outputs. Each asset in the system could be analysed in this way, and some water utilities have their own ‘stocks and flows’ models, such as the hydrological models of a water distribution system.

However, Tool 401 is based on a statistical probability approach, not the stocks and flows approach. In order to incorporate systems analysis without losing the strength of an asset-by-asset approach, two systems analysis fields are introduced into the Object Matrix used by Tool 401. Conceptually the tool uses these fields to tell the asset what other parts of the system may cause it to fail, so that the probability of such failures occurring is captured in the calculations of the risks to the asset.

The Object Matrix system analysis fields that capture system dependence are: ‘Dependent Assets’ and ‘Precedent Assets’. The first field is a list of the assets that are uniquely dependent upon the asset in question for their ability to operate. The second field sets out the assets upon which the asset in question depends in order to operate.

Precedent Assets are all of the assets that are uniquely required for the asset in question to operate. From a risk point of view they are also the assets that can transfer a risk to the asset they ‘precede’. In Tool 401 this field only covers ‘important assets’.

The ‘horizon’ of dependency is deemed to cease once there are multiple flow options, i.e., at the point of bifurcation in the system. Obviously a system could be vulnerable to failure at multiple flow routes, but the risks decrease sharply in any system that has redundancy and at this point. To accurately capture of risk at bifurcation points is a more complex exercise, but can be done.

Overall, this approach is a hybrid-systems analysis: it seeks to maintain the independence of stand-alone analysis of assets, while also capturing the risk of failure due to asset inter-dependence.

Computationally the systems analysis process has been structured to maximise processing speed and avoid iterative rounds. This is accomplished by:
1. Ordering all assets by descending number of dependents.
2. Creating a register of asset failure risk that is populated as each asset is processed.
3. Adding in the asset failure risks for all precedent assets as each dependent asset is analysed, according to the statistical sum for series risks.
4. Allocating the precedent risk to the ‘Precedent Element’ of an asset.

The process above avoids the need to use multiple iteration cycles in the computational process. It does so because it pre-analyses assets using the system diagrams and via their dynamic reordering according to levels of dependence. In this way this process achieves a similar outcome as multiple iterations but in a fraction of the computation time.

Many assets have in built capacity which means that just because there is a disruption, there may not be an immediate impact on the services. For example, if the power supply to a wastewater pumping station fails, the asset may be able to go for many hours before the sumps are full and an overflow occurs. If crews are able to restore the asset to full operation then there will be no consequential impact and if they are not, then there will be consequences to customers or the environment.

To accommodate the effects of capacity and the ability of utilities to fix problems before there is any impact on asset services or the environment, Tool 401 has an embedded response time function.

Advanced users are able to set a Mean Response Time for a crew to reach and fix a problem in a network asset. Tool 401 modifies the risk of consequential impacts to KPIs determining the probability of the response time exceeding the storage time of an asset.

The response time is assumed to have a normal distribution about the mean. The standard deviation of response time is estimated at half of the response time. This is determined by applying the range rule for estimation of standard deviations, and assuming the range of average response time is from zero to twice the average response time.

The consequence are then modified by this probability, such that a consequence will be fully applied if the response time significantly exceeds the storage time, and tend towards zero as the response time is significantly less than the storage time. In between the relationship will follow the cumulative probability distribution function associated with a normal distribution.

Tool 401 is configured to provide a user with an estimate of the projected average annual impact (financial and non-financial) associated with (the statistical probability of) asset failures. This information may assist in implementing appropriate measures to mitigate, manage or transfer risks while ensuring the associated costs and non-financial impacts of these measures are within operational tolerances—even if impacts are not monetised.

When individual assets are affected by single extreme events and/or subject to more gradual degradation, these assets can ‘fail’, i.e., stop working for some length of time. Their failure is associated with two types of costs for the business:
The direct asset costs for re-instating the asset, which may include repairs or replacement.
The indirect consequential costs stemming from the asset's failure to operate. These consequential costs include both financial costs (e.g., paying for an alternative service supply while replacements are undertaken) and non-financial costs (e.g., damage to the environment). The failure of an asset can often have both financial and non-financial costs.

For simplicity's sake, Tool 401 expresses financial impacts in terms of real dollars and their present value of expenditure or savings. Non-financial impacts are referred to in terms of other Key Performance Indicators (KPIs), such as unplanned outages or a failure to meet quality standards; each of these KPIs will have its own associated metrics.

To unpack the Financial Risk Cost and non-financial KPI risks, we must separate the risk cost arising from an asset failure into two forms: (a) the Intrinsic Risk Cost; and (b) the Consequence Risk Cost.

The Intrinsic Risk Cost derives from any physical damage to an asset itself. This includes the financial costs associated with its reinstatement, repair or replacement. The Intrinsic Risk Cost must reflect the intrinsic relative monetary value of the damaged elements that make up the asset.

The Consequence Risk Cost is derived from the consequences of an asset performance failure impacting level of service or causing consequential loss. The Consequence Risk Cost focuses on (a) the value of services the asset provides in terms of customers, quality and compliance, plus any associated (direct) monetary value, (b) the cost of a loss of service.

Assuming the Intrinsic Risk Cost and Consequence Risk Cost are both monetised, their sum is captured as the annual Financial Risk Cost.

Financial Risk Cost ($)=Intrinsic Risk Cost ($)+Consequence Risk Cost ($)

In Tool 401, the overarching measure of risk is the ‘Financial Risk Cost’. This is the cost of projected average annual losses associated with one or more risk. At the highest level of computation, all Financial Risk Costs for all assets modelled for a given year are aggregated into a single Total Financial Risk Cost. (These can be disaggregated by the user within the tool).

All risks or KPIs are calculated and referred on an annual basis, by default. These can be summed across all years or summed with a discount rate applied to create a Net Present Value (NPV) of the Total Financial Risk Cost:

Total Financial Risk Cost (all yrs)=Σ Total Financial Risk Cost for each year

NPV Financial Risk Cost=Σ year=0 to n Present Value of Financial Risk Cost

(where n is the end year of inquiry)

To this end, Tool 401 allows a user to set the period of NPV analysis, n, and reports on the NPV for this period based on the above calculation.

Tool 401 provides annual calculations of the risk cost and KPI risk. It is important to note that all risks are presented on an annual basis unless otherwise stated.

It is often preferable to show changes to risks on year-on-year basis, rather than have this change concealed within an overall NPV. Showing year-on-year risk avoids the potential pitfall of the NPV masking problematic spikes in cash flows, or diminishing the importance of future cash flows (as their current value is heavily discounted over long periods).

In any year, the total risk cost comprises the risk cost associated with each asset selected for analysis. Tool 401 conducts and returns risk cost at multiple levels: the individual asset level, by asset class, and aggregated across all asset types.

Total Financial Risk Cost=Σ Risk Costs for Each Asset-Type

Financial Risk Costs for Each Asset-Type=F Financial Risk Costs for Each individual Asset of that Asset Type

The impacts on financial and non-financial KPIs are managed at the same time:

Total KPli Risk=Σ KPli Risk for Each Asset-Type

(where is i is the specific type of KPI measured)

KPli Risk for Each Asset Type=Σ KPli Risk for Each Asset of that Type

As is the case for multi-year totals, users can access these financial and non-financial risks via pivot-tables, impact maps and charts (Boxes 46 and 47).

The Intrinsic Risk Cost is the intrinsic risk to the asset itself. This cost is measured in monetary terms only. This class of asset risk cost is concerned solely with the risk of loss or damage to the asset itself. It does not include any costs associated with consequences of the asset's failure to provide services. Intrinsic risk cost is represented by box 33 in the entity diagram.

As noted above, the Consequence Risk Cost relates to the external impacts (both financial and non-financial) that result from asset performance disruption or failure.

The Consequence Risk Costs that can be covered in tool 401 may, in some embodiments, include the like of customer disruptions, environmental impacts, social impacts and economic impacts.

Let us recall the equations for impacts on KPIs already presented above:

Total KPli Risk=Σ KPli Risk for Each Asset-Type
(where i refers to the specific type of KPI measured)

KPli Risk for Each Asset Type=Σ KPli Risk for Each Asset of that Type

The Consequence Risk Costs must be calculated for each asset. In all cases these calculations are based on the asset's failure to perform in the system. This does not necessarily mean that the asset is damaged (although it could be), only that it has stopped providing its services (e.g. stopped operating).

KPliasset Risk=Asset Failure Probability×Associated KPli Consequence

Each indicator requires an appropriate interpretation of the KPI Consequential Risk Cost. For example, for an event that affects an asset with customer connections, such as a water reservoir, the most relevant KPI is customer disruptions. So in this case, the KPI is ‘customer disruption’, and the relationship between asset failure, customer connections and customer disruptions is as follows:

Customer Disruptions=Asset Failure Probability×Customer Connections

Considering the example of a reservoir that serves 1,000 homes. Its failure will result in 1,000 residential disruption events (these are not timed by the tool). If the probability of this failure occurring in the year 2050 were 1%, the KPIi Risk for this asset would be 10 residential supply disruptions per year.

The KPI consequence levels for each KPI type are located in tool 401 Object Matrix for each asset. These matrices essentially detail the effect of an asset failure event on each of the KPIs. These include customer disruption, commodity volumes, environmental receptors as well as the value of lost processing.

Some of these impacts have monetary consequences as well. If so, this can be calculated and added to the Asset Financial Risk Cost, as discussed earlier. For example, these might be the cost of a fine related to a environmental discharge, or customer payments for loss of service. These costs will always be expressed monetarily (dollars per year).

Consequence Cost=KPliasset Risk×KPli Value

The tool maintains a record of consequences associated the failure of each asset subtype. This record can be used if this information is not available for the individual asset. This can include financial and non-financial consequences related to project KPIs.

Extensive sets of Tool 401 results are saved in the databases and can be used for comparing assets and Adaptation options. The following sections provide a breakdown the major outputs. Note that when referring to ‘assets’ this can include any one of a ‘base’ asset as it is originally configured at the start of the analysis, a ‘business-as-usual’ asset which is maintained in keeping with a maintenance schedule and renewals strategy, and a ‘adapted’ asset which is deliberately altered to increase its resilience to one or more identified hazards.

The tool calculates, as per the computational methods above, the mean probability of failure for the following:

(a) Each included asset in each year

(b) Each asset broken down by hazard

(c) Each asset broken down by element

(d) Each element broken down by hazard

These are available to be viewed in expandable pivot tables, CSV files and charts. The overarching asset is can be viewed in the heat maps.

The probability that an asset will fail is also used to calculate consequential financial and KPIs risks, discussed below.

The tool calculates the total cost of risk due to both damage to the asset and the consequential costs of the failure of the asset to provide its services. These include:

(a) The total financial risk cost asset in each year

(b) The financial risk cost broken down by hazard

These are available in expandable pivot tables, CSV files and charts.

Several consequential risks are non-financial or have non-financial KPls, which can be presented in suitable units.

To make large volumes of complex information as accessible as possible, the outputs are presented in a variety of means including:

Expandable tables for each data set

Charts for each of the KPIs

‘Heat maps’ which show the data overlaid on geospatial maps of the selected area

Dynamic charts and heat maps which show how the results progress with time

Charts showing comparison of adapted, business-as-usual and base assets

Charts comparing various adaptation options

Net Present Values of the adaptation options

The process of adaptation entails first understanding the nature and extent of a problem and then considering solutions.

Tool 401 encourages the user to test their selected assets before considering adaptation actions. And the way the data is provided, as discusses above (a) allows users to identify which assets carry the most risk (b) which KPIs are impacted most significantly by each asset (c) how these risks evolve over time.

The system then allows for any selected year, the user to look at why such problems are occurring (a) in terms of which elements are failing and/or causing high costs, and (b) which hazards are giving rise the risk.

Overall this provides a great deal of detail for the user to prioritise and detail their adaptation actions and it might be expected that a user with decide on adaptation actions based on:

(a) The assets causing the most significant costs to the business

(b) The hazards causing the most significant costs to the business

(c) The time at which risks breach business KPIs

(d) The cost effectiveness of actions available to address the risks

The adaptation aspects of tool 401 have been designed to provide two approaches. The first approach provides users with almost total control of any individual asset with the ability to change almost any aspect of the asset as a means to improve its resilience. The second is designed for ease of use and broad scale actions covering large numbers of asset at once—called the Adaptation Library These are discussed in more detail below.

An Adaptation Library feature of Tool 401 was created to allow users the ability to save adaptation strategies for repeated use.

By way of example a user may choose to waterproof all of the electrical, electronic and power elements of 50 assets at a certain year in the future. All of this can be achieve is a single step using the Adaptation Library.

The tool does cannot allow all fields of asset to be adapted using Adaptation Library functions, as many are not suitably structured for generic instructions. So there are some limitations that occur using the library that do not occur when adapting asset by asset.

A particular powerful feature of the library is that it allows users to write their own library functions, specifying what changes are to be made, which asset types and sub-types they can be applied to, and providing a name and description that make these functions available to other users.

### Adaptation Interface

An adaptation interface enables one or more adaptation actions to be made available to users. Users can create these adaptation actions by altering one or more asset elements.

The adaptation actions selected by users are implemented with reference to a year or forced with a trigger (e.g., level of sea level rise). A sequence of actions can be created for a single asset.

It is possible to apply a series of adaptation actions to an asset designated as Business-As-Usual (BAU) to allow users to assess the expected asset management plan against climate change. Such assets can be created with all same functions as an adapted asset, but are tagged as BAU.

Once the user has considered the risk analysis of a Base version of an asset, the model requires them to specify the adaptation actions to apply to the assets they have selected and assessed. This is done using an interface, which provides considerable flexibility in crafting single adaptation actions as well as a series of adaptation actions.

On the adaptation interface tab, each asset element has its material, dimensions and performance qualities (e.g., ‘waterproof-ness’) displayed as fields. Making an adaptation essentially involves changing one of the fields at a specified time (year). This is referred to as an adaptation action. Multiple actions per element or even multiple elements can be changed at the same time, or these changes may be staggered over time. Multiple adaptation actions carried out in a single year must be grouped as a single adaptation action.

Users are initially asked to specify which of the changes they make are performed to create a BAU profile; this profile signifies any changes to the asset the users would expect to occur under a normal renewals program, as contrasted with a climate change adaptation plan for the asset which is above and beyond BAU.

Once they enter the area of the interface where asset changes are made, users can work through each Asset Elements that is available for that asset. All of the Object Matrix fields are available for change via the Adaptation Interface. 10 shows an example for the civil element of an asset.

The adaptation actions available to the user are many; they range from removing or relocating the asset, through to appropriate changes of asset attributes in relation to the many fields in the Object Matrix that define an asset. The available options are limited only by the restrictions the administrator assigns.

In general, the adaptation interface aims to allow the user to apply a wide range of plausible adaptation actions. Some of these actions will be element-specific (such as materials or elevations) and others will be more broadly applicable to the asset (such as location or asset sub-type). Essentially a user can customise the adaptation actions and ensemble of actions, and is therefore not limited by current practice or standardised approaches.

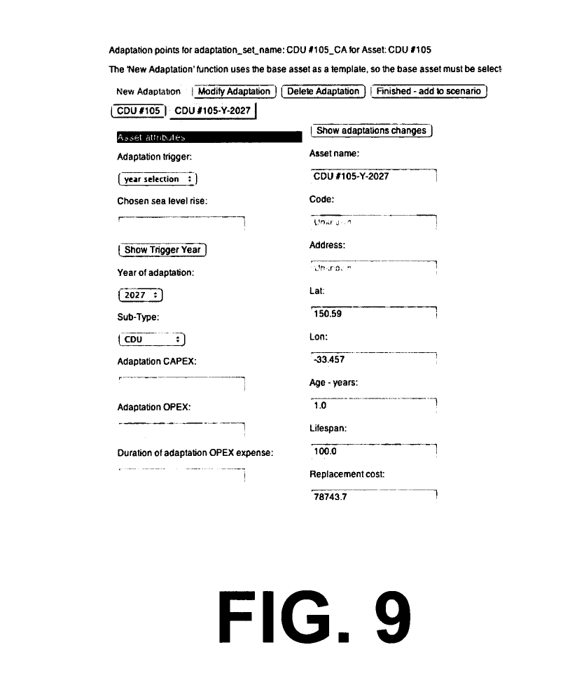

Ensembles of actions are also possible. Each ensemble is separated and ordered by the tool under the year of action, with each new phase of the assets' life given a specific code (see FIG. 9).

The actions are automatically grouped under each year of trigger. The model applies the sequence of actions as they arise, year by year, in the processing. As a result of these actions a new ‘adapted’ asset is created, which is added to the asset list available for (re)analysis by the user.

The driver for this type of detailed adaptation capability comes from the way the tool is inherently structured and how information about an asset is configured. This may overwhelm some users due to the large of amount of control/options, and for this reason an intermediate level of simplified adaptation is available by using pre-configured ‘generic actions’.

Once adaptation actions and ensembles are complete, they are stored by the system for ongoing testing by the user, for example, against different settings for climate scenarios. These adaptation actions and ensembles are stored as a series of discrete ‘objects’ in the asset databases.

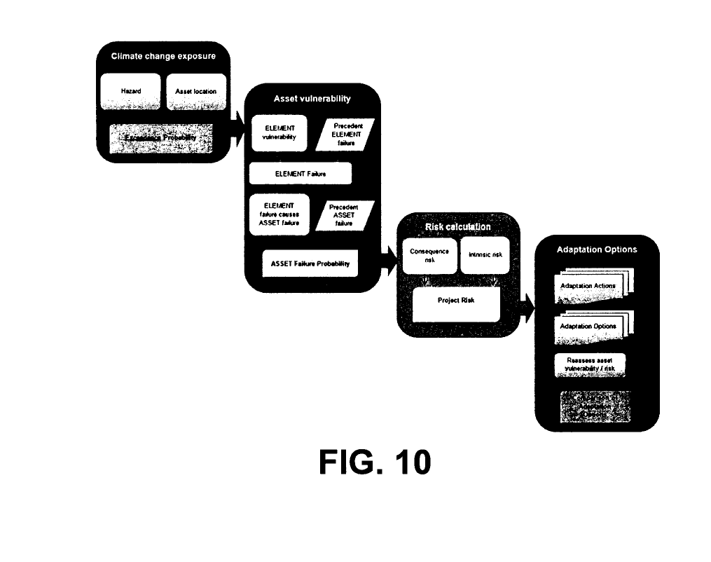

Referring to FIG. 10, the tool described herein provided functionality to quantify and project probability of damage and failure of assets by existing hazards and those made worse by climate change for sewerage assets (pipes, pumping stations and treatment plants) and water assets (pipes, pumping stations, treatment plants and chemical dosing units). This includes:

Assessing the assets' exposure to climate change hazards: The tool allows users the flexibility to select which hazards to assess and the source of the hazard information (databases store multiple different hazard spatial layers and data sets from reputable scientific and government institutions to enable user flexibility to select information). Assets are assessed geographically for a user selected climate change and impact scenarios. The likelihood of the climate change hazard events occurring (based on an annual probability exceedance) at that location is drawn from spatial (mapped) data for current hazards held in the databases and projected for any year in the future based a comprehensive set of hazard algorithms.

Quantifying the impact of the hazard/s on water and sewerage assets: To quantify the impact, the tool determines the extent to which each individual asset is vulnerable to the selected hazard. To determine asset vulnerability, the tool breaks the asset into its component elements (civil, electrical, mechanical, etc.) and uses the major material characteristics of each component part to establish its damage threshold and failure points of each. The tool also considers how these elements work together and affect each other to determine which asset elements are therefore vulnerable based on the probability of damage/failure of each element material. If the element fails then the probability of the asset failing as a whole is assessed including the flow-on consequences to other assets and system operation. The tool also has the ability to include risk of failure based on the original design standards and degradation.

Calculating risk to the utility in both financial and non-financial terms: Financial and non-financial key performance indicators used to quantify impacts include: annual risk of asset failure, risk of dry weather overflow, risk of environmental discharge into different categories of receiving water, equivalent number of residential customer service outages, risk cost (projected average annual financial loss) per year, loss of water quality and the cost of water ingress or egress, net present value of adaptation actions or ensembles of actions, cash flow and net present value of cash flow.

Comparing costs and benefits of multiple adaptation options: Once the risk cost of impacts is determined by the tool, a sequence of adaptation options can be compared (either by selecting actions from a pre-populated library of typical existing industry responses or by creating new actions). The efficacy of an adaptation option is determined by re-evaluation of the impacts of climate change on the adapted assets, and can be compared to the un-adapted asset or alternative options.

### Identifying if an Asset is Exposed

Hazard maps are imported from GIS files. These are, in one embodiment, ‘mapped’ into a Django web framework (which is a data management and web management system) via a specific GeoDjango framework extension for managing spatial data sets. Once in local databases, the information can be accessed on a location-specific basis. GIS data is not stored or used as GIS layers in the system, and instead is stored with intrinsic geo-referencing. This means that information about hazards at specific locations is accessible by location.

In some cases additional spatial layers of data are needed to establish the required context for a risk to occur. For example, since pipe cracking occurs mainly in clay soils, the tool database must also hold data on soil type.

Data is acquired from hazard maps once an asset has been selected for analysis. The tool obtains the relevant location of the assets from the associated Object Matrix, looks up the hazards that the users have requested be scrutinised, and acquires the data from each of the hazard maps available.

Assets must be placed in space in order for the tool to be able to assess whether the asset will be exposed to a hazard. Both the location (latitude and longitude) and the elevation (digital elevation model) are used to determine if a hazard such as sea level rise is a threat to an asset. These spatial data sets are extracted in real time.

### Asset Spatial Data

Utilities can provide spatial attributes of the assets as either latitude and longitude attributes (in the Object Matrix see below) for each asset, or in the form of GIS layers that are then converted to Object Matrix location data.

GIS layers can be queried for asset location or other asset attribute data. Every entry in GIS layers has a unique spatial position and a unique code for asset identification. In most cases the location of each unique asset is generated from the GIS layers. The latitude and longitude data links assets to other spatial data, e.g. hazards or digital elevation model (DEM).

In some embodiments, assets are located by a centroid point. For facility, storage and network types of assets this location is nominally the centre of the asset site. For mains (water/sewerage) the centroid is the centre of linear geometry of the main, even though some pipes may be curved.

The Object Matrix includes a field for ground height. A DEM is generally required to determine the height of ground level, from which civil elevations for the asset such as floor heights and relative levels can be. For example, Sydney Water provided a Digital Terrain Model (DTM) with one-metre contour lines. To interpolate between contours, this was converted into a DEM by Climate Risk using ESRI software. Ground heights for assets are taken by querying the DEM at the centroid location of the asset.

### Unique Asset Information—Object Matrix

The tool is able to take into account the unique characteristics of each and every asset. Essentially, an asset is managed by the tool as a series of ‘objects’ that capture the different phases of the asset's life over the analysis period. An object is defined by (in the present embodiment) 90 fields in an asset matrix known as the Object Matrix.

### Probability of the Hazard Event Occurring

Once the tool has established if an asset is in a location exposed to the selected hazard, the tool then calculates the annual probability of a hazard event occurring that may damage or disrupt the asset. An asset in an area of forest can be exposed to bushfires, but that does not mean that every year there will be a bushfire. Instead a bushfire may occur only once every 10, 20 or 50 years. To calculate the cost of risk the tool needs to know, or to calculate, what the actual probability of occurrence is each year, and how it might vary due to climate change.

The probability of a hazard event occurring is measured using an Annual Exceedance Probability (AEP), which is the probability that a threshold for this hazard will be crossed. For example, the probability per year that flood waters will exceed 1 metre. AEPs for each of the hazard events is the central statistical basis for risk calculations and provide the basis of probability of events occurring that carry through all probability calculations for elements, assets and combinations of assets.

In some cases the hazard event and therefore AEP is generic—like the probability of a bushfire—whereas in other cases the event and therefore its AEP has to be defined by the asset—like threshold height at which flood waters will exceed floor level or the speed at which a wind gust will exceed the design standards of the building.

The tool calculates location specific AEPs annually for each hazard event based on:
1. Identifying the type or threshold of the event to be considered (based on the asset failure thresholds as described in section 0)
2. Acquiring data from GIS layers for the specific location of the asset (see below for further explanation)
3. Adjusting the AEP due to selected climate change projections and time (explained in more detail below)

These AEPs are then altered to reflect the impact of climate change either by direct calculation of the new AEPs in each year or using a Climate Change Adjustment Coefficient (CCAC). This is calculated as follows:

Hazard AEP_{year n}=Hazard AEP_{year 1}×CCAC_{year n}

Data sources for climate change projections are diverse and highly variable in terms of how they present climate information: from highly specific quantified mapping to broad scale regional indicators. However, these data sets are able to be synthesised into a set of actual AEPs or CCACs for each selectable climate change scenario. Some cases the climate change projection data is spatial, and as such must be acquired using the spatial acquisition systems developed for the assets.

In the cases the data from the hazard maps cannot be used directly because some level of interpolation is required to extract the required AEP. The tool uses regression functions to do this. These apply a curve fit to a set of data, so that a universal relationship is established for the parameters, this then allows the probability of a specific threshold to be extracted. The nature of the curve that is fit to the data is based on literature research of the industry best practice.

For example, in the case of flood risk to an asset:
1. The height of the effective floor level is taken from the Object Matrix for that asset.
2. The height of flooding for at least three return frequencies at the asset's location are acquired from the GIS layer data stored in the tool's databases.
3. A log-normal or other appropriate curve is created using this data to derive the projection curve for flood height versus AEP.
4. Using this curve, the AEP for the threshold failure heights is calculated.

### Asset Exposure Summary

Using the approach described above, the tool identifies the exposure of the assets and how likely it is for a hazard event to occur in a particular location for different climate scenarios. This section of the report demonstrated how the tool methodically calculates whether an asset is exposed to a hazard, and the probability of a damaging hazard event occurring each by referencing historical data and climate change projections. This information is used by the tool in the next step to help identify how vulnerable an asset is to damage and failure.

### Determining Asset Vulnerability

The risk arising from a (climate change related) hazard requires both exposure to a hazard and a level of vulnerability to the hazard (i.e. the situation exceeds an assets capacity to operate). Once the exposure of an asset (or group of assets) has been assessed then the tool uses the following process and information to assess the asset vulnerability:
(a) Establish which asset materials are susceptible for each hazard event—using the Object Matrix and Material Performance Database.
(b) Establish which asset elements are therefore vulnerable to each hazard event based on the probability of damage/failure of the material.
(c) Determine the thresholds at which the element will fail and probability of the asset failing as a whole if the element fails.
(d) Determine the flow on consequences to other elements due to the failed element—using Element Dependency Matrix.
(e) Determine the flow on consequences to other assets and system operation due to the failed asset—using the Object Matrix ‘dependency horizon’.

These aspects of the tool are discussed in detail below.

### Design Vulnerability

In some cases materials are the best means to assess the vulnerability of asset (e.g. heat damage) or element and in some cases the design of the asset or element overall is a better indicator (e.g. wind damage).

The tool has the ability to maintain information on the design specification for an individual asset or asset class, and the tool can then test the probability that this specification will be exceeded in a given year. The specification can also be exceeded by degradation of the asset over time.

The design specification is particularly useful for elements of an asset where the performance of the whole is more that the sum of the parts. Thus the ability of a structure to withstand high winds is more impacted by the design specifications of the structure that the materials used.

This envelope can be changed by the user as part of the settings or suite of adaptation actions.

Material Vulnerability

The important requirement for the tool is that the hazard can be meaningfully interpreted in terms of its impact on the materials that make up an asset or its overarching design standards. The relationship between materials and hazard driven failure is carefully constructed via the Material Failure Coefficients. The Material Failure Coefficient (MFC) for a given material and hazard is the probability that the element using this material will fail when exposed to a specified hazard event.

The Material Performance Database is a catalogue of the MFCs that are used to test element materials against the hazards to which they are exposed.

The tool can in some circumstances use a conditional trigger to assess whether the environment in which the asset operates is needed to determine if the failure mode is relevant in that situation. For example, the brittleness of pipe materials is relevant when considering the problem of soil expansion and contraction in soils which are prone to expansion and contraction (e.g., clay based soils), and when analysing the likelihood of a hazard likely to cause contraction of soils (e.g., drought). Thus an MFC for pipe cracking can be invoked if there are clay soils present and if the effect of drought is being analysed.

The tool uses ‘design overrides’ to determine if the elements if the elements in an asset have design with features that override calculations based on normal material behaviour. This feature addresses the limitation of MFCs where an asset element or asset has been designed to manage the underlying material characteristic. For example, although some mechanical systems become strained between 40° C. and 50° C., it is possible to extend the upper temperature threshold for a mechanical system's operation by changing the design (e.g., by using a secondary material as a protective layer or coating). Similarly, materials can be waterproofed or protected against corrosion.

### Deriving Material Failure Coefficients for Materials

The MFCs used in the tool were derived using many different methods that included:
Empirical data from historical experience was used to establish a mathematical relationship.
Probability distribution of hazards and material relationships.
Extrapolation of known relationship for equivalent materials.
Standard engineering parameters for materials that can be used to predict a materials performance to different hazards
The use of design proxies that build on the design specifications of an asset to infer the failure thresholds of the materials.

It should be noted that in other cases it is not possible to directly infer the probability of failure. Instead a range of material response can be used to create a MFC for a given material. For example, where structural failure is concerned, Ultimate Strength clearly quantifies material strength. However, the actual risk of failure is affected by thickness and design. Therefore, the MFC for structural failure must be complemented by other information about the asset from the utility's Object Matrix—such as rated design performance to a hazard.

For other materials and hazards the impacts are not as clearly defined. In these cases MFCs were derived from probability distributions of hazards and material relationships, analysis of historical trends, or industry expertise. For example, the ability of a material to withstand a bushfire depends on the heat intensity of the bushfire; for a projected future this can only be estimated using a probability distribution. Similarly, the probability of a motor overheating in a heat wave depends on many design characteristics. Since these characteristics cannot be known by the tool, a probability of overheating could in future be derived based on a large sample of historical experience.

### Failure Thresholds

The point at which some elements fail when exposed to a hazard will usually change from asset to asset depending on its materials and the MFCs for that material. Thus with a material specified for the element (as retrieved from the Object Matrix databases) the tool is able to calculate the level of each hazard at which the element will fail, otherwise referred to as the failure threshold.

In some cases a failure thresholds may be associated with design issues rather than a material. For example the failure threshold for electrical elements in floodwater is associated with the height of the water, and more specifically if the water level breaches the floor height of the civil structure.

The failure threshold is very important as it is be used to specify the probability of such a threshold being exceeded. Functionally the tool calculates the probability of a failure threshold occurring using probability distribution algorithms. Thus, once a failure threshold is known for a given material/element, the tool is able to go to the hazard map data and climate change projection algorithms to calculate the AEP of such an event occurring for each year being analysed. This is then made available for all of the risk analysis.

### Element Interdependency

Many elements depend on other elements to be able to function. For example the mechanical element needs the electrical, electronic and power elements to be working in order to function. Therefore, the tool must capture the effect that one element failing may have on other elements.

This is done by firstly importing data into the analysis from databases that document the dependent elements of each element in the asset. These dependencies are held in the element dependency matrices. Secondly the tool takes the risks for each element and passes them on to dependent elements using statistically appropriate summation equations.

The summation equations are carefully constructed so as to avoid double counting and over estimating risk for elements that have multiple precedent elements.

### Asset Failure Probability

The next step is to determine the probability of the asset failing as a whole if the element fails. The probability that the asset will fail is referred to as the Asset Failure Probability. This depends on the hazard, and the exposure and vulnerability of each of the elements. The aggregation of the element risks is carried out based on the assumption that these are risks in series.

Asset Failure Probability=^{statistical}Σₑₗₑₘₑₙₜₛ(Element Failure Probability×Failure Dependence)

Element Failure Probability=Hazard AEP×Exposure Coefficient×Element Vulnerability

The Failure Dependency tells the tool whether the element failure results in the asset as a whole being inoperable. When all summed together for each element, this provides the overall Asset Failure Probability.

### Systems Analysis

If the asset fails then the tool determines how this affects other assets and consequentially the system as a whole.

Typical ‘systems analysis’ code is based on stocks and flows, for example, inputs, storage, internal flows and outputs. Each asset in the system could be analysed in this way, and some water utilities have their own ‘stocks and flows’ models, such as the hydrological models of the distribution system.

the tool uses a statistical probability approach, in order to incorporate systems analysis without losing the strength of an asset-by-asset approach. The Object Matrix captures data on each asset to tell the tool what dependency exist both upstream and downstream of the unique asset. As a result the tool calculates and statistically sums the probability of precedent asset failures occurring as another source of risk to the asset.

The Object Matrix system analysis uses ‘horizon fields’ that capture system dependence which are: ‘Dependent Assets’ and ‘Precedent Assets’. The first field is a list of the assets that are uniquely dependent upon the asset in question for their ability to operate. The second field sets out the assets upon which the asset in question depends in order to operate. The dependent and precedent assets were generated by hand using network diagrams for important assets. Overall, this approach is a hybrid-systems analysis: it seeks to maintain the independence of stand-alone analysis of assets, while also capturing the risk of failure due to asset inter-dependence.

Precedent Assets are all of the assets that are uniquely required for the asset in question to operate. From a risk point of view they are also the assets that can transfer a risk to the asset they ‘precede’. In the tool the precedent field only covers the following asset classes: water reservoirs, water pumping stations, water filtration plants, and sewage pumping stations and sewage treatment plants (i.e. does not include pipes, odour control units or chemical dosing units).

The ‘horizon’ of dependency is deemed to cease once there are multiple flow options, i.e., at the point of bifurcation in the system. Obviously a system could be vulnerable to failure at multiple flow routes, but the risks decrease sharply in any system that has redundancy and at this point. To accurately capture of risk at bifurcation points is a more complex exercise and this facility is not deemed to add significant value to the tool at this point.

Computationally the systems analysis process has been structured to maximise processing speed and avoid iterative rounds. This is accomplished by:

Ordering all assets by descending number of dependents.

Creating a register of asset failure risk that is populated as each asset is processed.

Adding in the asset failure risks for all precedent assets as each dependent asset is analysed, according to the statistical sum for series risks.

This process averts the need to use multiple iteration cycles in the computational process. It does so because it pre-analyses assets using the system diagrams and via their dynamic reordering according to levels of dependence. In this way this process achieves the same outcome as multiple iterations but in a fraction of the computation time.

### Adaptation Options

Once the risk cost of impacts is determined, the tool can then assess adaptation options to determine the comparative costs and benefits.

To perform adaptation, the tool requires users to specify adaptation options (a single action or a sequence of adaptation actions). Actions can be developed either by selecting from a pre-populated adaptation action library of typical existing industry responses or by creating customised asset specific adaptation actions. The timing (year) of adaptation actions can also be set by the user.

The efficacy of an adaptation option is determined by re-evaluation of the impacts of climate change on the assets, and can be compared to the un-adapted asset or alternative options. To enable the comparison of adaptation options, the tool has a dedicated content management system for processing the time dependent data associated with each asset. The adaptation process involves:
Selecting a sub-set of assets that will be adapted as identified by the user;
Applying adaptation actions to the asset(s), either from a pre-populated library or by creating a new adaptation action that changes one of the Object Matrix fields such as asset element, material, dimensions and/or performance qualities;
Assigning the year of implementation of each action;
Assigning capital and/or operational expenditures associated with the action;
Re-analysing the asset risks, costs and consequences;
Aggregating the overall performance of all of the assets with or without adaptation to allow the options to be compared.

### Identifying Assets Requiring Adaptation

The tool is configured to present failure risks, risk costs and impacts on some KPIs for each asset and allows the user to reorder the assets to see the most impacted assets to enable the user to select the asset/s that require adaptation. This is achieved using a dynamic table with the functionality for ordering by field, in ascending and descending order and limiting the number of results prioritised for presentation.

Since the tool calculates risks, costs and consequences per element and hazard the ‘intermediate results’ are also structured for presentation to enable the user to see what hazards need to be addressed and which elements require adaptation.

### Adapting the Assets

The tool has the ability to apply literally dozens of adaptation actions depending on the complexity of the asset. In principle all 90 fields in the Object Matrix can be modified to effectively describe an adaptation action. The types of adaptation changes that can be made in the tool include:
Change the asset subclass to a less vulnerable subclass (e.g. dry well pumping station to submersible pumping station). This represents a significant change to a number of fields within the Object Matrix.
Change an element's material to a material less susceptible to a hazard.
Design overrides, such as heat-proofing and water-proofing of each element, or changes to the asset's size and position (including elevation and size of some civil components).
Renewing or replacing asset (like for like). This can be done by modifying the age and lifetime fields in the Object Matrix.

The tool requires the user to assign capital and annual operational costs to an adaptation action that is then folded into the net present value calculations.

To make these adaptations to an asset the tool provides pre-populated adaptation actions designed for ease of use and broad scale actions covering large numbers of asset at once.

### Asset Specific Adaptation Actions

The asset fields in the Object Matrix are used as the building blocks for calculating vulnerability and exposure. The tool is structured so that each field can be changed for one or more elements of the asset/s. In doing so this step forces changes to the risk profile all the way through the tool's suite of risk calculations when the tool is re-analysed.

The tool has been structured so that adaptation actions and ensemble of actions are customised in the adaptation specification process, and are therefore not limited by current practice or standardised approaches. Therefore, the asset specific adaptation actions allow a wide range of adaptation actions. Some of these actions will be element-specific (such as materials or elevations) and others will be more broadly applicable to the asset (such as location or asset subclass).

Functionally the tool draws on specifications for the asset itself and the asset subclass from the databases. These are presented in the adaptation sections of the tool to (a) show the user how the base asset is specified for many of the 90 fields; and (b) the options available to re-specify the asset.

Making an adaptation essentially involves changing one of the Object Matrix fields such as asset element material, dimensions and performance qualities (e.g. ‘water-resistance’) at a specified time (year). This is referred to as an adaptation action. Multiple actions per element or even multiple elements can be changed in the same year, or these changes may be staggered over time.

The tool processes the changes to each asset element to calculate the change in the asset vulnerability and therefore risk cost. Error! Reference source not found. shows an example of an adaptation action being developed in the tool.

The available actions are limited only by the restrictions the administrator assigns.

The tool applies the sequence of actions as they arise, year by year, in the processing. As a result of these actions an ‘adapted’ asset is created.

The asset specific approach reflects the level for detail and access available from the tool. However, this may overwhelm some users due to the large of amount of control/options, and for this reason an intermediate level of simplified and more rapidly implemented adaptation has been created via the Adaptation Action Library functions of the tool.

### Managing Uncertainty

There are many types of uncertainty which affect the tool from more formal expressions of uncertainty such as those associated with climate change projections to more informal estimates used to accommodate ranges of opinion or variations in specifications.

The tool has been structured to accommodate uncertainty by allowing for ranges of data in many variables sampled by the tool. In general, uncertainty is specified by the type of distribution used (e.g. normal distribution), and some expression of the range (e.g. standard deviation or highest/lowest percentiles).

In this section the ways in which uncertainty is managed for assets and hazards is discussed in detail.

### Exemplary Client-Server Arrangement

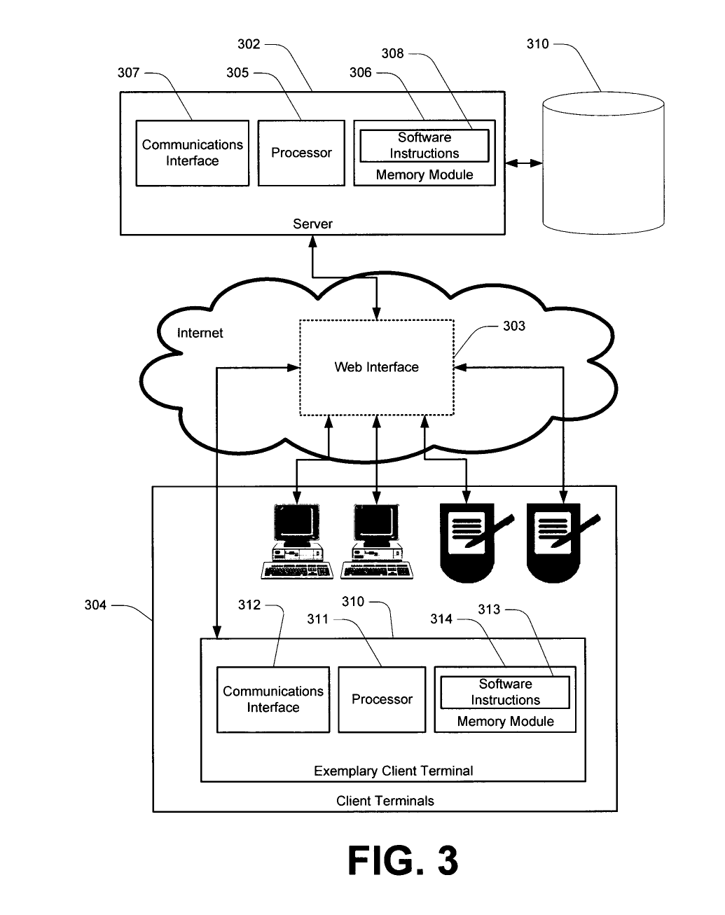

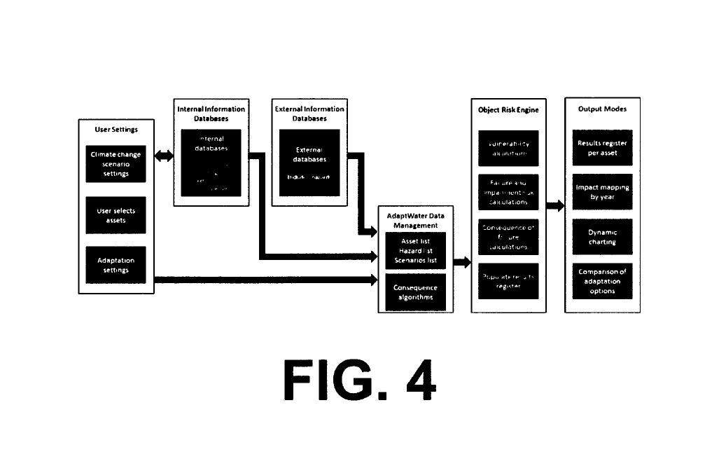

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided to configure and trigger the computational points of the tool on the main (non-chart) server.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure above provides various significant to computer implemented frameworks and methodologies for enabling risk analysis for a system comprising a plurality of physical assets.

Unless specifically stated otherwise, as apparent from the following discussions, it is appreciated that throughout the specification discussions utilizing terms such as “processing,” “computing,” “calculating,” “determining”, “analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for performing risk analysis for a system including a plurality of physical assets, the method including:
for each asset, defining an asset data item;
for each asset data item, maintaining data indicative of:
(i) dependent assets, being other assets which will fail in response to a failure of the asset;
(ii) precedent assets, being other assets in respect of which failure will cause failure for the asset;
operating a risk assessment engine thereby to perform a risk assessment for the system, wherein the risk assessment engine determines an inherent asset failure risk value for each asset; and
maintaining a register of asset failure risks, which is populated with inherent asset failure risk values for the asset items as those are determined for the asset in isolation; and
for each asset, combining the inherent asset failure risk value for that asset with asset failure risk values for its precedent assets, thereby to define a total asset failure risk value of the asset.

2. A method according to claim 1 including, upon calculation to a total asset failure risk value for a given asset, providing that value to all dependent assets of the given asset.

3. A method according to claim 1 wherein the risk assessment engine is configured to determine inherent asset risk failure values for the assets in descending order of number of dependents.

4. A method according to claim 1 wherein combining the inherent asset failure risk value for a given asset with asset failure risk values for its precedent assets is based upon a statistical sum for series risks.

5. A method according to claim 1 wherein each asset data item includes data indicative of at least one of the dependent assets and precedent assets for its associated asset.

6. A computer implemented method for performing risk analysis for a system including a plurality of physical assets, the method including:
for each asset, defining an asset data item; and
for each asset data item, defining one or more element data items respectively indicative of elements that constitute the asset;
wherein one or more of the element data items represent external supply systems that affect operation of the asset, and wherein failure probabilities are defined for each external supply system.

7. A method according to claim 6 wherein the failure probabilities are condition dependent.

8. A method according to claim 6 wherein the external supply systems which are required by the asset to operate properly and include one or more of power supply, water supply, physical access, and telecommunications service supply and/or any other external supply.

9. A computer system configured to perform a method according to claim 1.

10. A computer system configured to perform a method according to claim 1.

11. (canceled)
